(19) United States
(12) Patent Application Publication
(10) Pub. No.: US 2012/0288004 A1
(43) Pub. Date: Nov. 15, 2012

(54) IMAGE PROCESSING APPARATUS AND IMAGE PROCESSING METHOD

(76) Inventor: Kazushi Sato, Kanagawa (JP)

(21) Appl. No.: 13/521,221

(22) PCT Filed: Jan. 6, 2011
(86) PCT No.: PCT/JP2011/050100

§ 371 Date: Jul. 9, 2012

(30) Foreign Application Priority Data
Jan. 15, 2010 (JP) 2010006907

(51) Int. Cl. H04N 7/32

(52) U.S. Cl. 375/240.16; 375/E07.243

(57) ABSTRACT

The present invention relates to an image processing apparatus and an image processing method capable of improving an efficiency due to motion prediction. Blocks B₀₀, B₁₀, . . . , and B₃₃ in units of 4×4 pixels included in a macro block in units of 16×16 pixels are illustrated. Assuming that motion vector information on each block is mv₀₀, mv₁₀, . . . , and mv₃₃, in a Warping mode, only the motion vector information mv₀₀, mv₃₀, mv₀₃, and mv₃₃ for the blocks B₀₀, B₃₀, B₀₃, and B₃₃ at four corners of the macro block is added to a header of a compressed image sent to the decoding side. Other motion vector information is calculated by linear interpolation based on the motion vector information on the blocks B₀₀, B₃₀, B₀₃, and B₃₃ at four corners. The present invention is applicable to an image encoding apparatus that performs encoding based on H.264/AVC system, for example.

### TECHNICAL FIELD

The present invention relates to an image processing apparatus and an image processing method, and more particularly, to an image processing apparatus and an image processing method that achieve an improvement in efficiency due to motion prediction.

### BACKGROUND ART

In recent years, an apparatus that compresses and encodes an image is being spread by adopting an encoding system where image information is digitally dealt with, at that time, transmission and accumulation of the information at a high efficiency are aimed for, and by utilizing a redundancy unique to the image information, compression is carried out by orthogonal transform such as discrete cosine transform and motion compensation. Examples of this encoding system include MPEG (Moving Picture Experts Group).

In particular, MPEG2 (ISO/IEC 13818-2) is defined as a general-purpose image encoding system, which is a standard covering both of an interlaced scanning image and a non-interlaced scanning image as well as a standard resolution image and a high definition image. For example, MPEG2 is currently widely used in broad application for a professional use and a consumer use. The use of the MPEG2 compression system enables allocation of a code amount (bit rate) of 4 to 8 Mbps for an interlaced scanning image of standard definition having 720×480 pixels, for example. By using the MPEG2 compression system, for example, a code amount (bit rate) of 18 to 22 Mbps is allocated in the case of an interlaced scanning image of a high resolution having 1920×1088 pixels. Therefore, it is possible to realize a high compression rate and a satisfactory image quality.

This MPEG2 is mainly targeted for high image quality encoding in conformity to a broadcasting use but is not compatible with a code amount (bit rate) lower than MPEG1, that is, an encoding system with a still higher compression rate. With the spread of mobile terminals, in the time to come, needs for such encoding system are expected to increase, and to cope with this, standardization of an MPEG4 encoding system has been carried out. With regard to the image encoding system, its specification was approved as an international standard in December 1998 as ISO/IEC 14496-2.

Furthermore, in recent years, with an aim of an image encoding for a TV meeting use, standardization of a standard called H.26L (ITU-T Q6/16 VCEG) progresses. As compared with conventional encoding systems such as MPEG2 and MPEG4, it is known that H.26L requires more computation amounts for its encoding and decoding but realizes a still higher encoding efficiency. Also, currently, as part of activities on MPEG4, based on this H.26L, functions which are not supported by H.26L are also introduced, and standardization for realizing a still higher encoding efficiency has been carried out as Joint Model of Enhanced-Compression Video Coding. This has become an international standard under the name of H.264 and MPEG-4 Part 10 (Advanced Video Coding; hereinafter referred to as H.264/AVC) in March 2003.

Moreover, as an extension thereof, standardization of encoding tools necessary for business use, such as RGB, 4:2:2, or 4:4:4, and FRExt (Fidelity Range Extension) including 8×8DCT defined in the MPEG-2 and quantization matrix has been completed in February 2005. This achieves the encoding system capable of favorably expressing film noise contained in a movie by using the H.264/AVC, and has been used for wide applications such as Blu-Ray Disc™.

However, in recent years, there are increasing needs for encoding with a higher compression ratio, such as compression of an image of about 4000×2000 pixels, which is four times as large as a high-definition image, or delivery of a high-definition image under an environment of limited transfer capacity, such as the Internet. For this reason, in the VCEG (=Video Coding Expert Group) under the ITU-T described above, an improvement in encoding efficiency has been continuously discussed.

Incidentally, for example, in MPEG2 system, motion prediction/compensation processing is performed in units of 16×16 pixels in a frame motion compensation mode and in units of 16×8 pixels in a field motion compensation mode for each of a first field and a second field.

On the other hand, in the motion prediction and compensation in the H.264/AVC system, the macro block size is 16×16 pixels, while motion prediction/compensation is carried out with a variable block size.

FIG. 1 is a diagram showing an example of a block size for motion prediction/compensation in the H.264/AVC system.

In the upper stage of FIG. 1, macro blocks having 16×16 pixels and segmented into partitions of 16×16 pixels, 16×8 pixels, 8×16 pixels, and 8×8 pixels are sequentially illustrated from the left side. In the lower stage of FIG. 1, partitions of 8×8 pixels divided into sub partitions of 8×8 pixels, 8×4 pixels, 4×8 pixels, and 4×4 pixels are sequentially illustrated from the left side.

Specifically, in the H.264/AVC system, one macro block can be divided into partitions of 16×16 pixels, 16×8 pixels, 8×16 pixels, or 8×8 pixels, and can have independent motion vector information. The partitions of 8×8 pixels can be divided into sub partitions of 8×8 pixels, 8×4 pixels, 4×8 pixels, or 4×4 pixels, and can have independent motion vector information.

As described above with reference to FIG. 1, in the H.264/AVC system, the macro block size is 16×16 pixels. However, the macro block size of 16×16 pixels is not optimum for a large picture frame such as UHD (Ultra High Definition; 4000×2000 pixels) targeted for next-generation encoding system.

In this regard, Non-Patent Document 1 and the like propose a technique for expanding the macro block size to 32×32 pixels, for example.

FIG. 2 is a diagram showing an example of a block size proposed in Non-Patent Document 1. In Non-Patent Document 1, the macro block size is expanded to 32×32 pixels.

In the upper stage of FIG. 2, macro blocks formed of 32×32 pixels divided into blocks (partitions) of 32×32 pixels, 32×16 pixels, 16×32 pixels, and 16×16 pixels are illustrated from the left side. In the middle stage of FIG. 2, blocks formed of 16×16 pixels divided into blocks of 16×16 pixels, 16×8 pixels, 8×16 pixels, and 8×8 pixels are sequentially illustrated from the left side. In the lower stage of FIG. 2, blocks of 8×8 pixels divided into blocks of 8×8 pixels, 8×4 pixels, 4×8 pixels, and 4×4 pixels are sequentially illustrated from the left side.

Specifically, the macro blocks of 32×32 pixels can be processed in the blocks of 32×32 pixels, 32×16 pixels, 16×32 pixels, and 16×16 pixels illustrated in the upper stage of FIG. 2.

The blocks of 16×16 pixels illustrated on the right side of the upper stage can be processed in the blocks of 16×16 pixels, 16×8 pixels, 8×16 pixels, and 8×8 pixels illustrated in the middle stage, in the same manner as in the H.264/AVC system.

The blocks of 8×8 pixels illustrated on the right side of the middle stage can be processed in the blocks of 8×8 pixels, 8×4 pixels, 4×8 pixels, and 4×4 pixels illustrated in the lower stage, in the same manner as in the H.264/AVC system.

These blocks can be classified into three hierarchies. Specifically, the blocks of 32×32 pixels, 32×16 pixels, and 16×32 pixels illustrated in the upper stage of FIG. 2 are referred to as a first stage layer. The blocks of 16×16 pixels illustrated on the right side of the upper stage and the blocks of 16×16 pixels, 16×8 pixels, and 8×16 pixels illustrated in the middle stage are referred to as a second hierarchy. The block of 8×8 pixels illustrated on the right side of the middle stage and the blocks of 8×8 pixels, 8×4 pixels, 4×8 pixels, and 4×4 pixels illustrated in the lower stage are referred to as a third hierarchy.

By employing the hierarchical structure as shown in FIG. 2, regarding the blocks of 16×16 pixels and the subsequent blocks, larger blocks are defined as a super set while maintaining the compatibility with the macro block in the present AVC.

Note that Non-Patent Document 1 proposes a technique for applying an expanded macro block to an inter-slice, and Non-Patent Document 2 proposes a technique for applying an expanded macro block to an intra-slice.

### CITATION LIST

### Non-Patent Document

Non-Patent Document 1: “Video Coding Using Extended Block Sizes”, VCEG-AD09, ITU-Telecommunications Standardization Sector STUDY GROUP Question 16-Contribution 123, January 2009
Non-Patent Document 2: “Intra Coding Using Extended Block Sizes”, VCEG-AL28, July 2009

### DISCLOSURE OF INVENTION

### Problems to be Solved by the Invention

Incidentally, as proposed in Non-Patent Document 1 described above, when the motion compensation block size becomes larger, the optimum motion vector information within the block is not always uniform. However, in the technique proposed in Non-Patent Document 1, it is difficult to perform the motion compensation processing corresponding to the size, which causes deterioration in encoding efficiency.

The present invention has been made in view of the above-mentioned circumstances, and can achieve an improvement in efficiency due to motion prediction.

### Solution To Problems

An image processing apparatus according to a first aspect of the present invention includes: motion search means for selecting a plurality of sub blocks according to a macro block size from a macro block to be encoded, and for searching motion vectors of selected sub blocks; motion vector calculation means for calculating motion vectors of non-selected sub blocks by using the motion vectors of the selected sub blocks and a weighting factor according to a positional relation in the macro block; and encoding means for encoding an image of the macro block and the motion vectors of the selected sub blocks.

The motion search means can select sub blocks at four corners from the macro block.

The motion vector calculation means calculates a weighting factor according to a positional relation between the selected sub blocks in the macro block and the non-selected sub blocks, and multiplies and adds the calculated weighting factor and the motion vectors of the selected sub blocks to calculate the motion vectors of the non-selected sub blocks.

The motion vector calculation means can use linear interpolation as a method for calculating the weighting factor.

The motion vector calculation means can perform rounding processing of the calculated motion vectors of the non-selected sub blocks on a prescribed motion vector accuracy after multiplication of the weighting factor.

The motion search means can search the motion vectors of the selected sub blocks by block matching of the selected sub blocks.

The motion search means can calculate a residual signal for any combination of motion vectors within a search range with respect to the selected sub blocks, and obtain a combination of motion vectors that minimizes a cost function value using the calculated residual signal to search the motion vectors of the selected sub blocks.

The encoding means can encode Warping mode information indicating a mode for encoding only the motion vectors of the selected sub blocks.

An image processing method according to a first aspect of the present invention includes: selecting, by motion search means of an image processing apparatus, a plurality of sub blocks according to a macro block size from a macro block to be encoded and searching motion vectors of the selected sub blocks; calculating, by motion vector calculation means of the image processing apparatus, motion vectors of non-selected sub blocks by using the motion vectors of the selected sub blocks and a weighting factor according to a positional relation in the macro block; and encoding, by encoding means of the image processing apparatus, an image of the macro block and the motion vectors of the selected sub blocks.

An image processing apparatus according to a second aspect of the present invention includes: decoding means for decoding an image of a macro block to be decoded and motion vectors of sub blocks selected according to a macro block size from the macro block upon encoding; motion vector calculation means for calculating motion vectors of non-selected sub blocks by using the motion vectors of the selected sub blocks decoded by the decoding means and a weighting factor according to a positional relation in the macro block; and predicted image generation means for generating a predicted image of the macro block by using the motion vectors of the selected sub blocks decoded by the decoding means and the motion vectors of the non-selected sub blocks calculated by the motion vector calculation means.

The selected sub blocks are sub blocks at four corners.

The motion vector calculation means can calculate a weighting factor according to the positional relation between the selected sub blocks in the macro block and the non-selected sub blocks, and can multiply and add the calculated weighting factor and the motion vectors of the selected sub blocks to calculate the motion vectors of the non-selected sub blocks.

The motion vector calculation means can use linear interpolation as a method for calculating the weighting factor.

The motion vector calculation means can perform rounding processing of the calculated motion vectors of the non-selected sub blocks on a prescribed motion vector accuracy after multiplication of the weighting factor.

The motion vectors of the selected sub blocks are searched and encoded by block matching of the selected sub blocks.

The motion vectors of the selected sub blocks are searched and encoded by calculating a residual signal for any combination of motion vectors within a search range with respect to the selected sub blocks and by obtaining a combination of motion vectors that minimizes a cost function value using the calculated residual signal.

The decoding means can decode Warping mode information indicating a mode for encoding only the motion vectors of the selected sub blocks.

An image processing method according to a second aspect of the present invention includes: decoding, by decoding means of an image processing apparatus, an image of a macro block to be decoded and motion vectors of sub blocks selected according to a macro block size from the macro block upon encoding; calculating, by motion vector calculation means of the image processing apparatus, motion vectors of non-selected sub blocks by using the decoded motion vectors of the selected sub blocks and a weighting factor corresponding to a positional relation in the macro block; and generating, by predicted image generation means of the image processing apparatus, a predicted image of the macro block by using the decoded motion vectors of the selected sub blocks and the calculated motion vectors of the non-selected sub blocks.

In the first aspect of the present invention, a plurality of sub blocks is selected according to a macro block size from the macro bocks be encoded, and motion vectors of the selected sub blocks are searched. Motion vectors of non-selected sub blocks are calculated using a weighting factor according to the motion vectors of the selected sub blocks and a positional relation in the macro blocks. The image of the macro blocks and the motion vectors of the selected sub blocks are encoded.

In the second aspect of the present invention, the image of the macro blocks to be decoded and the motion vectors of the selected sub blocks selected according to the macro block size from the macro blocks upon encoding are decoded, and motion vectors of non-selected sub blocks are calculated using the decoded motion vectors of the selected sub blocks and a weighting factor according to a positional relation in the macro blocks. Then, a predicted image of the macro blocks is generated using the decoded motion vectors of the selected sub blocks and the calculated motion vectors of the non-selected sub blocks.

Note that each of the image processing apparatuses may be an independent apparatus or may be an internal block forming a single image encoding apparatus or an image decoding apparatus.

### Effects of the Invention

According to the present invention, an improvement in efficiency due to motion prediction can be achieved. According to the present invention, an overhead is reduced to thereby improve the encoding efficiency.

### BRIEF DESCRIPTION OF DRAWINGS

FIG. 1 is a diagram illustrating variable block size motion prediction/compensation processing.

FIG. 2 is a diagram showing an example of an expansion macro block.

FIG. 3 is a block diagram showing a configuration according to an exemplary embodiment of an image encoding apparatus to which the present invention is applied.

FIG. 4 is a diagram illustrating motion prediction/compensation processing with a ¼ pixel accuracy.

FIG. 5 is a diagram illustrating a motion search method.

FIG. 6 is a diagram illustrating a motion prediction/compensation system for a multi-reference frame.

FIG. 7 is a diagram illustrating an example of a method for generating motion vector information.

FIG. 8 is a diagram illustrating a Warping mode.

FIG. 9 is a diagram illustrating another example of a block size.

FIG. 10 is a block diagram showing configuration examples of a motion prediction/compensation unit and a motion vector interpolation unit shown in FIG. 3.

FIG. 11 is a flowchart illustrating encoding processing of the image encoding apparatus shown in FIG. 3.

FIG. 12 is a flowchart illustrating intra-prediction processing in step S21 of FIG. 11.

FIG. 13 is a flowchart illustrating inter motion prediction processing in step S22 of FIG. 11.

FIG. 14 is a flowchart illustrating Warping mode motion prediction processing in step S54 of FIG. 13.

FIG. 15 is a flowchart illustrating another example of Warping mode motion prediction processing in step S54 of FIG. 13.

FIG. 16 is a block diagram showing a configuration according to an embodiment of an image decoding apparatus to which the present invention is applied.

FIG. 17 is a block diagram showing configuration examples of a motion prediction/compensation unit and a motion vector interpolation unit shown in FIG. 16.

FIG. 18 is a flowchart illustrating decoding processing of the image decoding apparatus shown in FIG. 16.

FIG. 19 is a flowchart illustrating prediction processing in step S138 of FIG. 18.

FIG. 20 is a block diagram showing a configuration example of a hardware of a computer.

FIG. 21 is a block diagram showing an example of a main configuration of a television receiver to which the present invention is applied.

FIG. 22 is a block diagram showing an example of a main configuration of a portable phone set to which the present invention is applied.

FIG. 23 is a block diagram showing a main configuration example of a hard disk recorder to which the present invention is applied.

FIG. 24 is a block diagram showing an example of a main configuration of a camera to which the present invention is applied.

FIG. 25 is a diagram illustrating an example of a coding unit defined by HEVC.

### MODE FOR CARRYING OUT THE INVENTION

Hereinafter, embodiments of the present invention will be described with reference to the drawings.

### [Configuration Example of Image Encoding Apparatus]

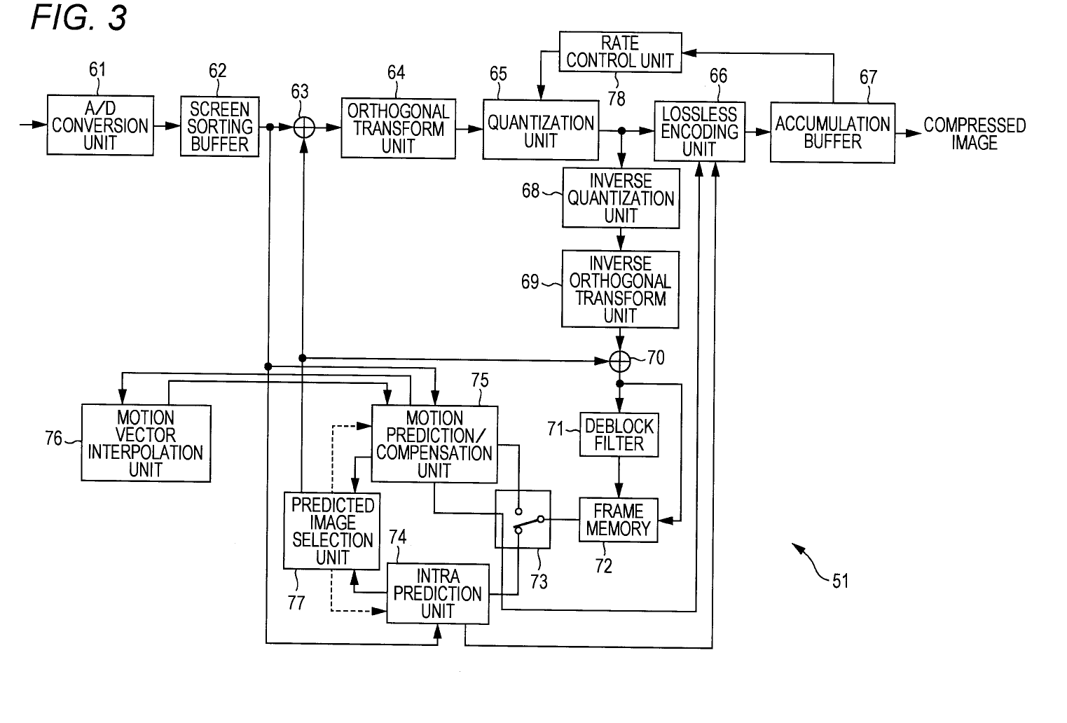

FIG. 3 illustrates a configuration according to an exemplary embodiment of an image encoding apparatus serving as an image processing apparatus to which the present invention is applied.

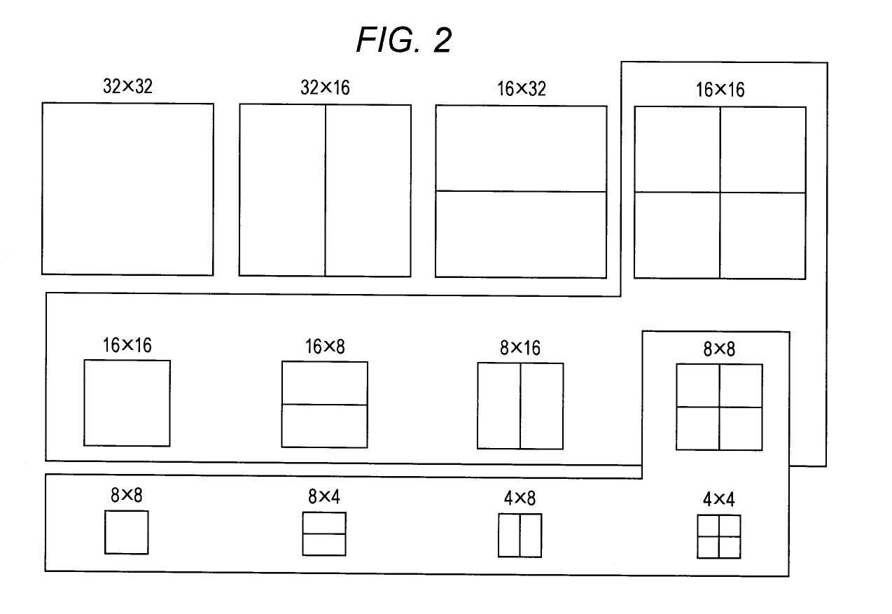

This image encoding apparatus 51 compresses and encodes an image based on H.264 and MPEG-4 Part 10 (Advanced Video Coding) (hereinafter referred to as H.264/AVC) systems. Specifically, in the image encoding apparatus 51, not only a motion compensation block mode specified in the H.264/AVC system, but also the expansion macro block described above with reference to FIG. 2 is used.

In the example shown in FIG. 3, the image encoding apparatus 51 includes an A/D conversion unit 61, a screen sorting buffer 62, an operation unit 63, an orthogonal transform unit 64, a quantization unit 65, a lossless encoding unit 66, an accumulation buffer 67, an inverse quantization unit 68, an inverse orthogonal transform unit 69, a computation unit 70, a deblock filter 71, a frame memory 72, a switch 73, an intra-prediction unit 74, a motion prediction/compensation unit 75, a motion vector interpolation unit 76, a predicted image selection unit 77, and a rate control unit 78.

The A/D conversion unit 61 performs A/D conversion on a received image, and outputs and stores the image into the screen sorting buffer 62. The screen sorting buffer 62 sorts the stored images of frames, which are in the order of display, in the order of frames to be encoded according to GOP (Group of Picture).

The operation unit 63 subtracts a predicted image, which is selected by the predicted image selection unit 77 and is received from the intra-prediction unit 74, or a predicted image received from the motion prediction/compensation unit 75, from the image read from the screen sorting buffer 62, and outputs difference information to the orthogonal transform unit 64. The orthogonal transform unit 64 performs orthogonal transform, such as discrete cosine transform or Karhunen-Loeve transform, on the difference information from the operation unit 63, and outputs the transform coefficient. The quantization unit 65 quantizes the transform coefficient output by the orthogonal transform unit 64.

The quantized transform coefficient output by the quantization unit 65 is input to the lossless encoding unit 66, and is subjected to lossless encoding, such as variable-length encoding or arithmetic coding, to be compressed.

The lossless encoding unit 66 obtains information indicating intra-prediction from the intra-prediction unit 74, and obtains information indicating an inter-prediction mode or the like from the motion prediction/compensation unit 75. Note that information indicating intra-prediction and information indicating inter-prediction are also referred to as intra-prediction mode information and inter-prediction mode information, respectively.

The lossless encoding unit 66 encodes the quantized transform coefficient, and encodes the information indicating intra-prediction and the information indicating the inter-prediction mode. The encoded information is used as a part of header information in a compressed image. The lossless encoding unit 66 supplies and accumulates the encoded data into the accumulation buffer 67.

For example, the lossless encoding unit 66 performs lossless encoding processing such as variable-length encoding or arithmetic coding. Examples of the variable-length encoding include CAVLC (Context-Adaptive Variable Length Coding) defined in the H.264/AVC system. Examples of the arithmetic coding include CABAC (Context-Adaptive Binary Arithmetic Coding).

The accumulation buffer 67 outputs data supplied from the lossless encoding unit 66 to a recording apparatus and a transmission line, which are not shown, at the subsequent stage, for example, as the compressed image encoded by the H.264/AVC system.

The quantized transform coefficient output by the quantization unit 65 is also input to the inverse quantization unit 68 and is inversely quantized and further subjected to inverse orthogonal transform by the inverse orthogonal transform unit 69. The output subjected to the inverse orthogonal transform is added to the predicted image supplied from the predicted image selection unit 77 by the computation unit 70, thereby obtaining a locally decoded image. The deblock filter 71 removes a block distortion in the decoded image, and supplies and accumulates it into the frame memory 72. An image obtained before the deblock filter processing by the deblock filter 71 is also supplied and accumulated into the frame memory 72.

The switch 73 outputs reference images accumulated in the frame memory 72 to the motion prediction/compensation unit 75 or the intra-prediction unit 74.

In this image encoding apparatus 51, for example, an I picture, a B picture, and a P picture from the screen sorting buffer 62 are supplied to the intra-prediction unit 74 as images to be subjected to intra-prediction (which is also referred to as intra processing). Also, the B picture and the P picture, which are read from the screen sorting buffer 62, are supplied to the motion prediction/compensation unit 75 as images to be subjected to inter-prediction (also called inter processing).

The intra-prediction unit 74 performs intra-prediction processing of all candidate intra-prediction modes based on the image, which is read from the screen sorting buffer 62 and subjected to intra-prediction, and based on the reference image supplied from the frame memory 72, and generates a predicted image. In this case, the intra-prediction unit 74 calculates a cost function value with respect to all candidate intra-prediction modes, and selects the intra-prediction mode in which the calculated cost function value provides a minimum value, as an optimum intra-prediction mode.

The intra-prediction unit 74 supplies the predicted image generated in the optimum intra-prediction mode and the cost function value thereof to the predicted image selection unit 77. When the predicted image generated in the optimum intra-prediction mode by the predicted image selection unit 77 is selected, the intra-prediction unit 74 supplies the information indicating the optimum intra-prediction mode to the lossless encoding unit 66. The lossless encoding unit 66 encodes this information, and uses the encoded information as a part of header information in the compressed image.

The motion prediction/compensation unit 75 is supplied with the image to be subjected to inter processing, which is read from the screen sorting buffer 62, and with the reference image from the frame memory 72 through the switch 73. The motion prediction/compensation unit 75 performs motion search (prediction) of all candidate inter-prediction modes, and performs compensation processing on the reference image by using the searched motion vector to thereby generate a predicted image.

Herein, in the image encoding apparatus 51, a Warping mode is provided as an inter-prediction mode. In the image encoding apparatus 51, motion search is also carried out in the Warping mode, and a predicted image is generated. In this mode, the motion prediction/compensation unit 75 selects a part of blocks (also referred to as sub blocks) from the macro block, and searches only the motion vectors of the selected part of blocks. The motion vectors of the searched part of blocks are supplied to the motion vector interpolation unit 76. The motion prediction/compensation unit 75 performs compression processing on the reference image by using the motion vectors of the searched part of blocks and the motion vectors of the remaining blocks calculated by the motion vector interpolation unit 76, thereby generating a predicted image.

The motion prediction/compensation unit 75 calculates cost function values for all candidate inter-prediction modes (including the Warping mode) by using the searched or calculated motion vectors. The motion prediction/compensation unit 75 decides the prediction mode that provides a minimum value, as the optimum inter-prediction mode, among the calculated cost function values, and supplies the predicted image generated in the optimum inter-prediction mode and the cost function value thereof to the predicted image selection unit 77. When the predicted image generated in the optimum inter-prediction mode is selected by the predicted image selection unit 77, the motion prediction/compensation unit 75 outputs the information (inter-prediction mode information) indicating the optimum inter-prediction mode to the lossless encoding unit 66.

At this time, the motion vector information, the reference frame information, and the like are also output to the lossless encoding unit 66. Note that in the Warping mode, only the motion vectors of the searched part of blocks in the macro block are output to the lossless encoding unit 66. The lossless encoding unit 66 performs lossless encoding processing, such as variable-length encoding or arithmetic coding, on the information from the motion prediction/compensation unit 75, and inserts the information into the header portion of the compressed image.

The motion vector interpolation unit 76 is supplied with the motion vector information on the searched part of blocks and the block address of the corresponding block within the macro block from the motion prediction/compensation unit 75. The motion vector interpolation unit 76 refers to the supplied block address, and calculates the motion vector information on the remaining blocks (specifically, non-selected sub blocks in the motion prediction/compensation unit 75) in the macro block by using the motion vector information on a part of blocks. Then, the motion vector interpolation unit 76 supplies the calculated motion vector information on the remaining blocks to the motion prediction/compensation unit 75.

The predicted image selection unit 77 decides an optimum prediction mode from the optimum intra-prediction mode and the optimum inter-prediction mode based on each cost function value output by the intra-prediction unit 74 or the motion prediction/compensation unit 75. The predicted image selection unit 77 selects a predicted image of the decided optimum prediction mode, and supplies the selected predicted image to each of the operation units 63 and 70. At this time, the predicted image selection unit 77 supplies the selected information on the predicted image to the intra-prediction unit 74 or the motion prediction/compensation unit 75.

The rate control unit 78 controls the rate of the quantization operation of the quantization unit 65 so as to prevent an overflow or an underflow from occurring based on the compressed image accumulated in the accumulation buffer 67.

### [Explanation of H.264/AVC System]

Next, the H.264/AVC system used as the basis in the image encoding apparatus 51 will be described.

For example, in the MPEG2 system, motion prediction/compensation processing with a ½ pixel accuracy is carried out by linear interpolation processing.

On the other hand, in the H.264/AVC system, prediction/compensation processing with a ¼ pixel accuracy using a 6-tap FIR (Finite Impulse Response Filter) filter as an interpolation filter is carried out.

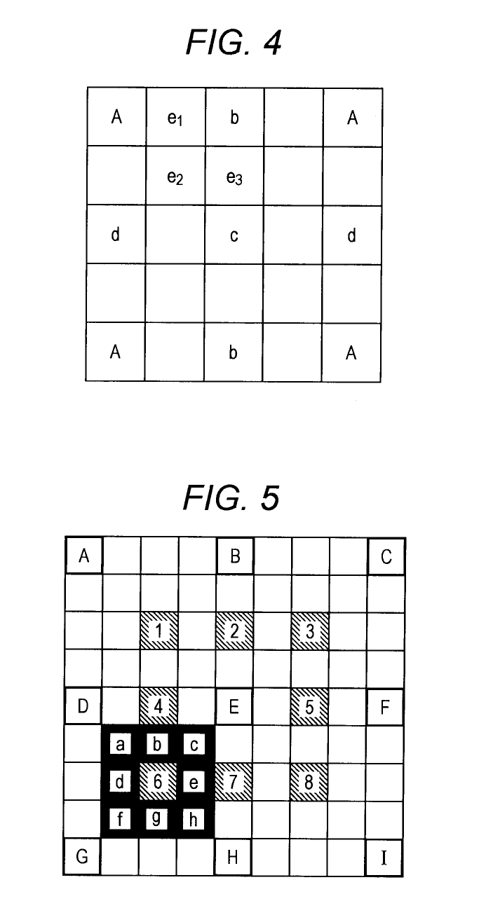

FIG. 4 is a diagram illustrating the prediction/compensation processing with a ¼ pixel accuracy in the H.264/AVC system. In the H.264/AVC system, the prediction/compensation processing with a ¼ pixel accuracy using a 6-tap FIR (Finite Impulse Response Filter) filter is carried out.

In the example shown in FIG. 4, a position “A” represents a position of an integer accuracy pixel; positions “b”, “c”, and “d” each represent a position of a ½ pixel accuracy; and positions “e1”, “e2”, and “e3” each represent a position of a ¼ pixel accuracy. First, Clip ( ) is defined below as the following Formula (1).

$$\begin{matrix}[ Formula 1 ] & \\ Clip 1 ( a ) = \{ \begin{matrix}0 ; & if ( a < 0 ) \\ a ; & otherwise \\ max\_pix ; & if ( a > max\_pix )\end{matrix} & ( 1 )\end{matrix}$$

Note that when the input image has a 8-bit accuracy, the value of max_pix indicates 255.

The pixel values at the positions “b” and “d” are generated as expressed by the following Formula (2) by using a 6-tap FIR filter.

[Formula 2]

F=A₋₂−5·A₋₁+20·A₀+20·A₁−5·A₂+A₃

b,d=Clip1((F+16)>>5) (2)

The pixel value at the position “c” is generated by the following Formula (3) by applying a 6-tap FIR filter in the horizontal direction and the vertical direction.

[Formula 3]

F=b₋₂−5·b₋₁+20·b₀+20·b₁−5·b₂+b₃

or

F=b₋₂−5·b₋₁+20·b₀+20·d₁−5·d₂+d₃

c=Clip1((F+512)>>10) (3)

Note that clip processing is executed only once at last, after execution of the AND-OR processing in each of the horizontal direction and the vertical direction.

The positions “e1” to “e3” are generated by linear interpolation as expressed by the following Formula (4).

[Formula 4]

e₁=(A+b+1)>>1

e₂=(b+d+1)>>1

e₃=(b+c+1)>>1 (4)

In order to obtain a compressed image of high encoding efficiency, it is important to use appropriate processing to select the motion vector obtained with the ¼ pixel accuracy. In the H.264/AVC system, a method implemented in reference software, which is called released JM (Joint Model), is used as an example of this processing.

Referring next to FIG. 5, the motion search method implemented in the JM will be described.

In the example shown in FIG. 5, pixels A to I represent pixels having pixel values of integer pixel accuracy (hereinafter referred to as “pixel with integer pixel accuracy”). Pixels 1 to 8 represent pixels having pixel values with the ½ pixel accuracy in the vicinity of the pixel E (hereinafter referred to as “pixels with the ½ pixel accuracy”). Pixels a to h represent pixels having pixel values with the ¼ pixel accuracy in the vicinity of the pixel 6 (hereinafter referred to as “pixels with the ¼ pixel accuracy”).

In the JM, as a first step, a motion vector of an integer pixel accuracy that minimizes a cost function value, such as SAD (Sum of Absolute Difference), is obtained within a predetermined search range. The pixel corresponding to the obtained motion vector is the pixel E.

Next, as a second step, the pixel having a pixel value that minimizes the above-mentioned cost function value is obtained from among the pixel E and the pixels 1 to 8 with the ½ pixel accuracy in the vicinity of the pixel E. This pixel (pixel 6 in the example shown in FIG. 2) is set as the pixel corresponding to the optimum motion vector with the ½ pixel accuracy.

Then, as a third step, the pixel having a pixel value that minimizes the above-mentioned cost function value is obtained from among the pixel 6 and the pixels a to h with the ¼ pixel accuracy in the vicinity of the pixel 6. As a result, the motion vector corresponding to the obtained pixel becomes the optimum motion vector with the ¼ pixel accuracy.

Furthermore, in order to achieve a higher encoding efficiency, it is important to select an appropriate prediction mode. The H.264/AVC system employs, for example, a method for selecting two mode determination methods of High Complexity Mode and Low Complexity Mode defined in the JM. In the case of using this method, a cost function value for each prediction mode Mode is calculated in each method, and a prediction mode for minimizing the cost function value is selected as an optimum mode for the block to the macro block.

The cost function value in High Complexity Mode can be obtained by the following Formula (5).

Cost (ModeεΩ)=D+λ×R (5)

In Formula (5), Ω represents a universal set of candidate modes for encoding the block to the macro block. D represents a difference energy of a decoded image and an input image in the case of performing encoding in the prediction mode Mode. Furthermore, λ represents a Lagrange's undetermined multiplier given as a function of a quantization parameter, and R represents a total code amount including the orthogonal transform coefficient when encoding is performed in the mode Mode.

That is, to perform encoding in the High Complexity Mode, it is necessary to perform temporary encoding processing once in all candidate modes Mode to calculate the parameters D and R described above. Accordingly, a higher computation amount is required.

On the other hand, the cost function value in the Low Complexity Mode can be obtained by the following Formula (6).

Cost (ModeεΩ)=D+QP2Quant(QP)×HeaderBit (6)

In Formula (6), D represents a difference energy of a predicted image and an input image, unlike the case of the High Complexity Mode. QP2Quant(QP) is given as a function of a quantization parameter QP. Further, HeaderBit represents a code amount relating to information belonging to Header, such as a motion vector and a mode, excluding the orthogonal transform coefficient.

Specifically, in Low Complexity Mode, it is necessary to perform prediction processing for each candidate mode Mode. However, no decoded image is required, so it is unnecessary to perform encoding processing. For this reason, a lower computation amount than that of the High Complexity Mode can be achieved.

In the H.264/AVC system, prediction/compensation processing for a multi-reference frame is also performed.

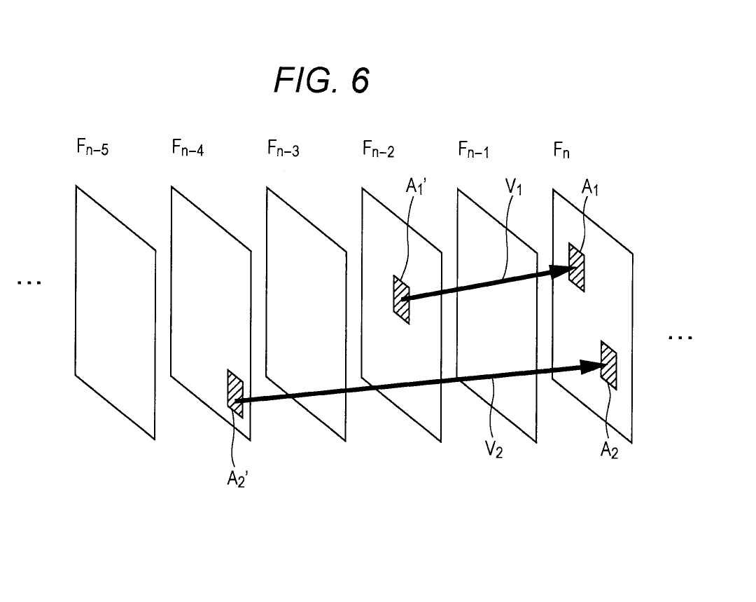

FIG. 6 is a diagram illustrating prediction/compensation processing for a multi-reference frame in the H.264/AVC system. In the H.264/AVC system, a motion prediction/compensation system for a multi-reference frame is defined.

In the example of FIG. 6, a target frame Fn to be encoded from now and encoded frames Fn-5, . . . , and Fn-1are illustrated. The frame Fn-1is a frame preceding the target frame Fn on the temporal axis. The frame Fn-2is a frame two frames before the target frame Fn. The frame Fn-3is a frame three frames before the target frame Fn. The frame Fn-4is a frame four frames before the target frame Fn, and the frame Fn-5is a frame five frames before the target frame Fn. In general, a smaller reference picture number (ref_id) is added to frames closer to the target frame Fn on the temporal axis. Specifically, the frame Fn-1has the smallest reference picture number, and the reference picture numbers increase in the order of the frames Fn-2, . . . , and Fn-5.

The target frame Fn indicates a block A1 and a block A2. The block A1 is correlated with a block A1′ of the frame Fn-2which is two frames before, and the motion vector V1 is searched. The block A2 is correlated with the block A1′ of the frame Fn-4which is four blocks before, and the motion vector V2 is searched.

As described above, in the H.264/AVC system, a plurality of reference frames is stored in a memory, and different reference frames can be referred to in a single frame (picture). Specifically, for example, the block A1 refers to the frame Fn-2, and the block A2 refers to the frame Fn-4. Thus, in a single picture, independent reference frame information (reference picture number (ref_id)) can be provided for each block.

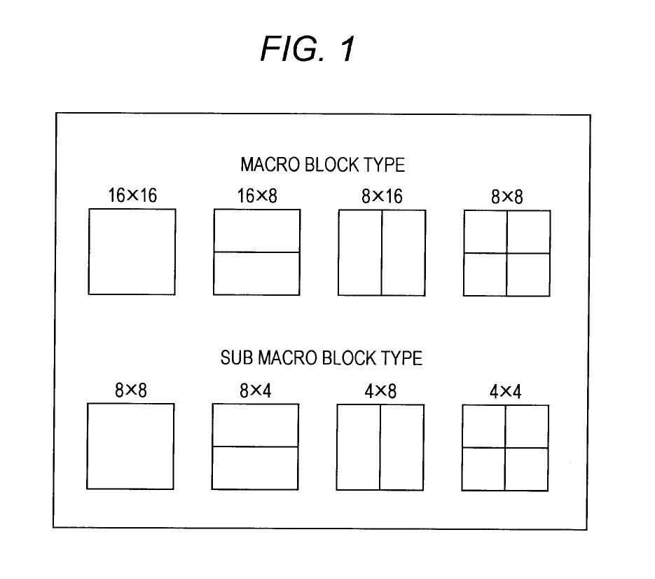

The block described herein refers to any of partitions of 16×16 pixels, 16×8 pixels, 8×16 pixels, and 8×8 pixels described above with reference to FIG. 1. The reference frames within 8×8 sub blocks should be the same.

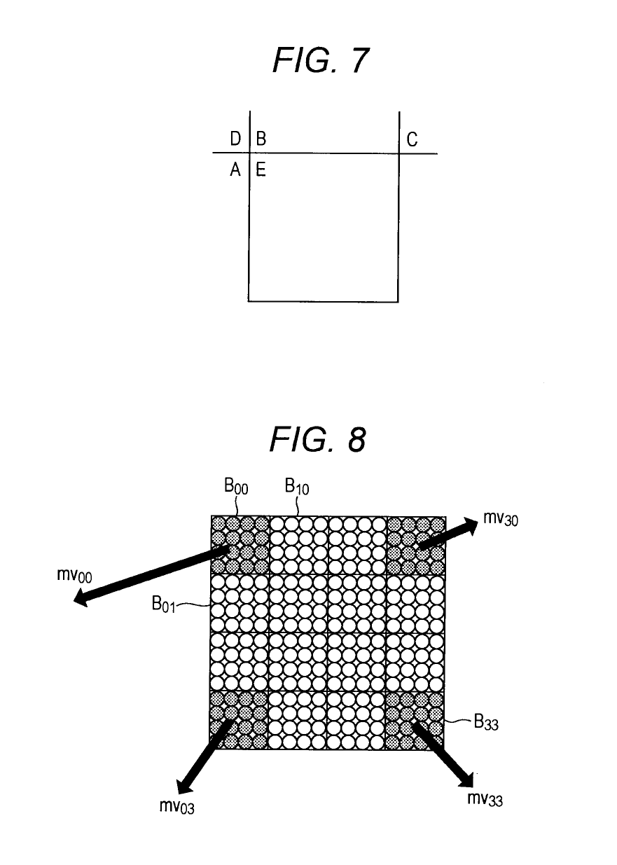

As described above, in the H.264/AVC system, motion prediction/compensation processing with the ¼ pixel accuracy described above with reference to FIG. 4 and motion prediction/compensation processing described above with reference to FIGS. 1 and 6 are performed, thereby generating a considerable amount of motion vector information. Direct encoding of the considerable amount of motion vector information causes deterioration in encoding efficiency. In the H.264/AVC system, on the other hand, a reduction in encoding information of the motion vector is achieved by the method shown in FIG. 7.

FIG. 7 is a diagram illustrating a method for generating motion vector information by the H.264/AVC system.

In the example shown in FIG. 7, the target block E (for example, 16×16 pixels) to be encoded from now and encoded blocks A to D adjacent to the target block E are illustrated.

Specifically, the block D is adjacent to the upper left of the target block E, and the block B is adjacent to the top of the target block E. The block C is adjacent to the upper right of the target block E, and the block A is adjacent to the left of the target block E. Note that the blocks A to D are not partitioned because the blocks represent any of the blocks having 16×16 pixels to 4×4 pixels described above with reference to FIG. 1.

For example, motion vector information for X (=A, B, C, D, E) is represented by mv_{X}. First, predicted motion vector information pmv_{E} for the target block E is generated as in the following Formula (7) by median prediction using motion vector information on the blocks A, B, and C.

pmv_{E}=med(mv_{A},mv_{B},mv_{C}) (7)

The motion vector information on the block C may be unavailable because the motion vector information is located at an end of a picture frame or is not encoded yet. In this case, the motion vector information on the block D is used as a substitute for the motion vector information on the block C.

As the motion vector information for the target block E, data mvd_{E} to be added to the header portion of the compressed image is generated as in the following Formula (8) by using pmv_{E}.

mvd_{E}=mv_{E}−pmv_{E} (8)

Note that, in fact, processing is independently performed on each component of the motion vector information in the horizontal direction and the vertical direction.

Thus, the predicted motion vector information is generated, and the difference between the predicted motion vector information and the motion vector information, which are generated based on the correlation between adjacent blocks, is added to the header portion of the compressed image, thereby reducing the motion vector information.

### [Detailed Configuration Example]

In the image encoding apparatus 51 shown in FIG. 3, the Warping mode is applied to the image encoding processing. In the image encoding apparatus 51, a part of blocks (sub blocks) is selected from the macro block by using the Warping mode, and only the motion vectors of the selected part of blocks are predicted. Then, only the predicted motion vectors of the part of blocks are sent to the decoding side. Calculation processing using the predicted motion vectors of the part of bocks is carried out on the motion vectors of the remaining blocks (specifically, non-selected sub blocks) in the macro block.

Referring to FIG. 8, the Warping mode will be described. In the example shown in FIG. 8, blocks B₀₀, B₁₀, . . . , and B₃₃ in units of 4×4 pixels included in the macro block in units of 16×16 pixels are illustrated. Note that these blocks are also referred to as sub blocks with respect to the macro blocks.

These blocks are motion prediction/compensation blocks, and the motion vector information for each block is set as mv₀₀, mv₁₀, . . . , and mv₃₃. In this case, in the Warping mode, only motion vector information mv₀₀, mv₃₀, mv₀₃, and mv₃₃ for blocks B₀₀, B₃₀, B₀₃, and B₃₃ at four corners of the macro block is added to the header of the compressed image to be sent to the decoding side. The other motion vector information is calculated such that a weighting factor is calculated according to the positional relation between the blocks at four corners and the remaining blocks as shown in Formula (9) based on the motion vector information mv₀₀, mv₃₀, mv₀₃, and mv₃₃, and the calculated weighting factor is multiplied and summed up by the motion vectors of the blocks at four corners. Linear interpolation is used, for example, as a method for calculating the weighting factor.

$$\begin{matrix}[ Formula 5 ] & \\ {mv}_{10} = \frac{2}{3} \cdot {mv}_{00} + \frac{1}{3} \cdot {mv}_{30} \\ {mv}_{20} = \frac{1}{3} \cdot {mv}_{00} + \frac{2}{3} \cdot {mv}_{30} \\ {mv}_{01} = \frac{2}{3} \cdot {mv}_{00} + \frac{1}{3} \cdot {mv}_{03} \\ {mv}_{02} = \frac{1}{3} \cdot {mv}_{00} + \frac{2}{3} \cdot {mv}_{03} \\ {mv}_{13} = \frac{2}{3} \cdot {mv}_{03} + \frac{1}{3} \cdot {mv}_{33} \\ {mv}_{23} = \frac{1}{3} \cdot {mv}_{03} + \frac{2}{3} \cdot {mv}_{33} \\ {mv}_{31} = \frac{2}{3} \cdot {mv}_{30} + \frac{1}{3} \cdot {mv}_{33} \\ {mv}_{32} = \frac{1}{3} \cdot {mv}_{30} + \frac{2}{3} \cdot {mv}_{33} \\ {mv}_{11} = \frac{4}{9} \cdot {mv}_{00} + \frac{2}{9} \cdot {mv}_{30} + \frac{2}{9} \cdot {mv}_{03} + \frac{1}{9} \cdot {mv}_{33} \\ {mv}_{21} = \frac{2}{9} \cdot {mv}_{00} + \frac{4}{9} \cdot {mv}_{30} + \frac{1}{9} \cdot {mv}_{03} + \frac{2}{9} \cdot {mv}_{33} \\ {mv}_{12} = \frac{2}{9} \cdot {mv}_{00} + \frac{1}{9} \cdot {mv}_{30} + \frac{4}{9} \cdot {mv}_{03} + \frac{2}{9} \cdot {mv}_{33} \\ {mv}_{22} = \frac{1}{9} \cdot {mv}_{00} + \frac{2}{9} \cdot {mv}_{30} + \frac{2}{9} \cdot {mv}_{03} + \frac{4}{9} \cdot {mv}_{33} & ( 9 )\end{matrix}$$

Note that when the motion vector information is based on the H.264/AVC system, the motion vector information is expressed with a ¼ pixel accuracy as described above with reference to FIG. 4. Accordingly, after the interpolation processing given by Formula (9), rounding processing to ¼ pixel accuracy is performed on each motion vector information.

In the conventional H.264/AVC system, it is necessary to send 16 pieces of motion vector information mv₀₀ to mv₃₃ to the decoding side in order to provide different pieces of motion vector information to all the blocks B₀₀ to B₃₃ within the macro block.

On the other hand, in the image encoding apparatus 51, all the blocks B₀₀ to B₃₃ within the macro block can be provided with different pieces of motion vector information by using the four pieces of motion vector information mv₀₀, mv₃₀, mv₀₃, and mv₃₃ as described above with reference to Formula (9). This enables reduction of the overhead within the compressed image to be sent to the decoding side.

In particular, as described above with reference to FIG. 2, when a larger block size than that of the conventional H.264/AVC system is used as the motion compensation block size, the probability that the motion within the motion compensation block is not uniform is higher than that of a smaller motion compensation block size. Accordingly, the improvement in efficiency due to the Warping mode can be increased.

Furthermore, when interpolation processing for the motion vector is carried out in units of pixels, the access efficiency to the frame memory 72 is decreased. However, in the Warping mode, interpolation processing for the motion vector is carried out in units of blocks, thereby preventing deterioration in the access efficiency to the frame memory 72.

Note that in the example of FIG. 8, the memory access is performed in units of 4×4 pixel blocks. This is the same as the size of the minimum motion compensation block in the H.264/AVC system shown in FIG. 1, and a cache used for motion compensation in the H.264/AVC system can be utilized.

In the above explanation with reference to FIG. 8, particularly the blocks to which the motion vector information is sent correspond to the blocks at four corners, that is, the selected blocks during motion search correspond to the blocks at four corners of B₀₀, B₃₀, B₀₃, and B₃₃. However, the blocks at four corners are not necessarily used, but any blocks may be selected as long as at least two blocks are used. For example, two blocks (two corners) at opposing corners among four corners may be used, or opposing blocks other than the blocks at corners may be used. Alternatively, blocks other than opposing corner blocks may be used. The number of blocks is not limited to an even number, but three or five blocks may be used.

In particular, blocks at four corners are used for the following reason. That is, in the case where the median prediction processing for the motion vector information described above with reference to FIG. 7 is carried out, when the block encoded by the Warping mode is located at an adjacent position, the computation amount by the median prediction can be reduced by using the motion vector information sent to the decoding side instead of the motion vector information generated by interpolation.

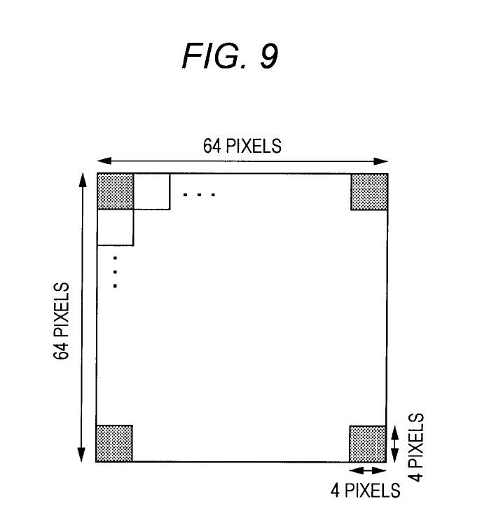

In the example shown in FIG. 8, the case where the macro block includes 16×16 pixels and the motion compensation block size is 4×4 pixels has been described. However, the present invention is not limited to the example shown in FIG. 8. As shown in the subsequent FIG. 9, the present invention is applied to any macro block size and any block size.

In the example shown in FIG. 9, blocks in units of 4×4 pixels included in the macro block in units of 64×64 pixels are illustrated. In this example, when all the motion vector information for the 4×4 pixel blocks is sent to the decoding side, 256 pieces of motion vector information are required. On the other hand, if the Warping mode is used, it is only necessary to send four pieces of motion vector information to the decoding side. This contributes to a considerable reduction in overhead within the compressed image. As a result, the encoding efficiency can be improved.

Note that also in the example of FIG. 9, the example where the motion compensation block size forming the macro block is 4×4 pixels has been described. However, the block size of 8×8 pixels or 16×16 pixels, for example, may also be used.

The motion vector information to be sent to the decoding side can be set variable without being fixed. In this case, the number of motion vectors or the block positions may be sent with the Warping mode information. Furthermore, the number of blocks of the motion vector information to be sent can be selected (variable) depending on the macro block size.

Furthermore, the Warping mode may be applied only to a larger block size than a certain block size, instead of being applied to all the block sizes shown in FIGS. 1 and 2.

The motion compensation system described above is defines as the Warping mode as one type of the inter macro block type. In the image encoding apparatus 51, the Warping mode is added as one candidate mode for inter-prediction. In the macro block, the above-mentioned cost function value or the like is used and selected when it is determined that the Warping mode achieves the highest encoding efficiency.

### [Configuration Examples of Motion Prediction/Compensation Unit and Motion Vector Interpolation Unit]

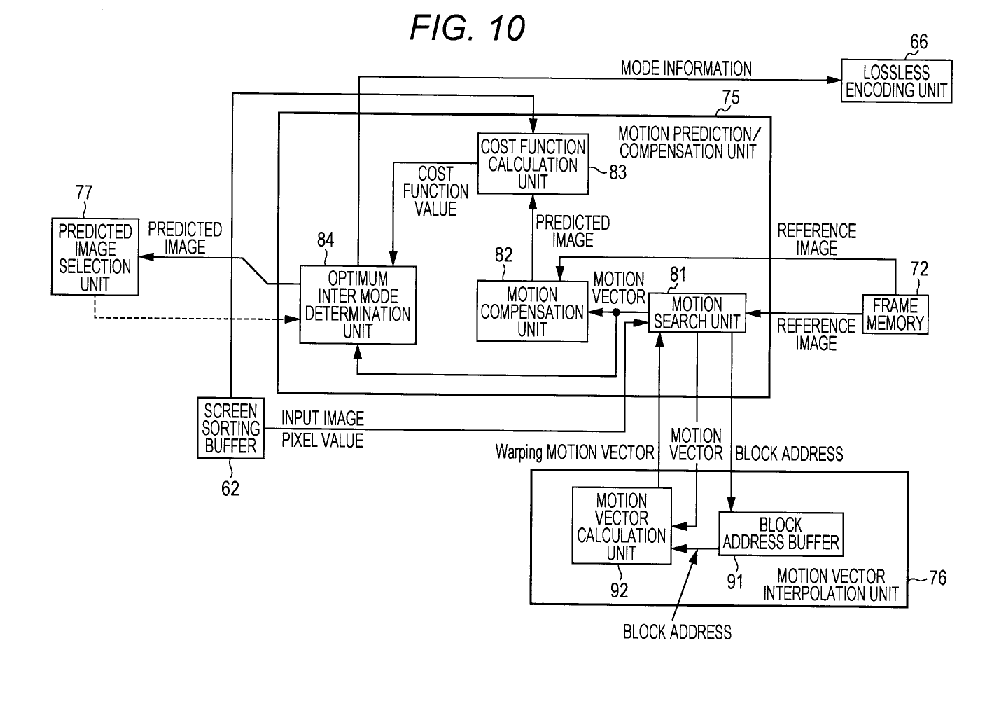

FIG. 10 is a block diagram showing detailed configuration examples of the motion prediction/compensation unit 75 and the motion vector interpolation unit 76. Note that in FIG. 10, the switch 73 shown in FIG. 3 is omitted.

In the example shown in FIG. 10, the motion prediction/compensation unit 75 includes a motion search unit 81, a motion compensation unit 82, a cost function calculation unit 83, and an optimum inter mode determination unit 84.

The motion vector interpolation unit 76 includes a block address buffer 91 and a motion vector calculation unit 92.

The motion search unit 81 receives the input image pixel value from the screen sorting buffer 62 and the reference image pixel value from the frame memory 72. The motion search unit 81 performs motion search processing for all inter-prediction modes including the Warping mode, decides optimum motion vector information for each inter-prediction mode, and supplies the information to the motion compensation unit 82.

At this time, the motion search unit 81 performs motion search processing only on the blocks at the corners (four corners) in the macro block, for example, in the Warping mode, supplies the block address of a block other than those at the corners to the block address buffer 91, and supplies the searched motion vector information to the motion vector calculation unit 92.

The motion search unit 81 is supplied with the motion vector information (hereinafter referred to as “Warping motion vector information”) calculated by the motion vector calculation unit 92. The motion search unit 81 decides the optimum motion vector information for the Warping mode based on the searched motion vector information and Warping motion vector information, and supplies the information to each of the motion compensation unit 82 and the optimum inter mode determination unit 84. Note that the motion vector information may be generated finally as described above with reference to FIG. 7.

The motion compensation unit 82 performs compensation processing on the reference image from the frame memory 72 by using the motion vector information from the motion search unit 81 to generate a predicted image, and outputs the generated predicted image to the cost function calculation unit 83.

The cost function calculation unit 83 calculates cost function values corresponding to all inter-prediction modes by Formula (5) or Formula (6) described above by using the input image pixel value from the screen sorting buffer 62 and the predicted image from the motion compensation unit 82, and outputs the predicted images corresponding to the calculated cost function values to the optimum inter mode determination unit 84.

The optimum inter mode determination unit 84 receives the cost function values calculated by the cost function calculation unit 83 and the corresponding predicted images, as well as the motion vector information from the motion search unit 81. The optimum inter mode determination unit 84 decides the minimum cost function value received, as the optimum inter mode for the macro block, and outputs the predicted image corresponding to the prediction mode to the predicted image selection unit 77.

When the predicted image corresponding to the optimum inter mode is selected by the predicted image selection unit 77, the predicted image selection unit 77 supplies a signal indicating the predicted image. Accordingly, the optimum inter mode determination unit 84 supplies the optimum inter mode information and the motion vector information to the lossless encoding unit 66.

The block address buffer 91 receives a block address of a block other than those at the corners in the macro block from the motion search unit 81. The block address is supplied to the motion vector calculation unit 92.

The motion vector calculation unit 92 calculates the Warping motion vector information of the block of the block address from the block address buffer 91, by using Formula (9) described above, and supplies the calculated Warping motion vector information to the motion search unit 81.

### [Explanation of Encoding Processing of Image Encoding Apparatus]

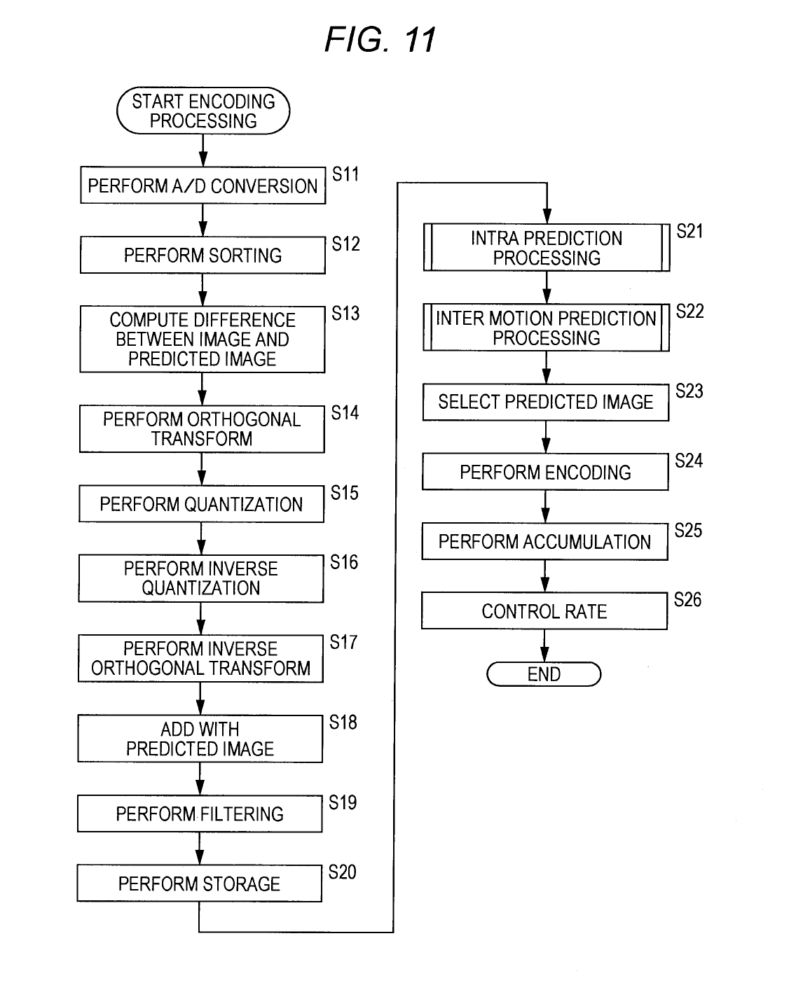

Referring next to the flowchart of FIG. 11, the encoding processing of the image encoding apparatus 51 shown in FIG. 3 will be described.

In step S11, the A/D conversion unit 61 performs A/D conversion on a received image. In step S12, the screen sorting buffer 62 stores the images supplied by the A/D conversion unit 61, and sequentially sorts the images from the order of display of each picture to the order of encoding.

In step S13, the operation unit 63 calculates a difference between the images sorted in step S12 and the predicted image. The predicted image is supplied from the motion prediction/compensation unit 75 in the case of performing inter-prediction, and from the intra-prediction unit 74 in the case of performing intra-prediction, to the operation unit 63 via the predicted image selection unit 77.

The amount of difference data is smaller than the amount of original image data. Accordingly, the amount of data can be compressed as compared to the case of directly encoding the image.

In step S14, the orthogonal transform unit 64 performs orthogonal transform on the difference information supplied from the operation unit 63. Specifically, orthogonal transform such as discrete cosine transform or Karhunen-Loeve transform is performed to output a transform coefficient. In step S15, the quantization unit 65 quantizes the transform coefficient. In the case of quantization, the rate is controlled in the manner as described in the processing in step S26 described later.

The difference information quantized as described above is locally decoded as described below. Specifically, in step S16, the inverse quantization unit 68 performs inverse quantization on the transform coefficient quantized by the quantization unit 65, based on the feature corresponding to the feature of the quantization unit 65. In step S17, the inverse orthogonal transform unit 69 performs inverse orthogonal transform on the transform coefficient subjected to the inverse quantization by the inverse quantization unit 68, based on the feature corresponding to the feature of the orthogonal transform unit 64.

In step S18, the computation unit 70 adds the predicted image to be input through the predicted image selection unit 77 to the difference information locally decoded, and generates a locally decoded image (image corresponding to the input to the operation unit 63). In step S19, the deblock filter 71 filters the image output by the computation unit 70, thereby removing a block distortion. In step S20, the frame memory 72 stores the filtered image. Note that the frame memory 72 is also supplied with images that are not subjected to filter processing by the deblock filter 71 from the computation unit 70, and stores the images.

When the image to be processed, which is supplied from the screen sorting buffer 62, is the image of the block to be subjected to intra processing, the decoded image to be referenced is read from the frame memory 72, and is supplied to the intra-prediction unit 74 via the switch 73.

Based on these images, in step S21, the intra-prediction unit 74 performs intra-prediction in all candidate intra-prediction modes for each pixel of the block to be processed. Note that pixels that are not subjected to deblock filtering by the deblock filter 71 are used as the decoded pixels to be referenced.

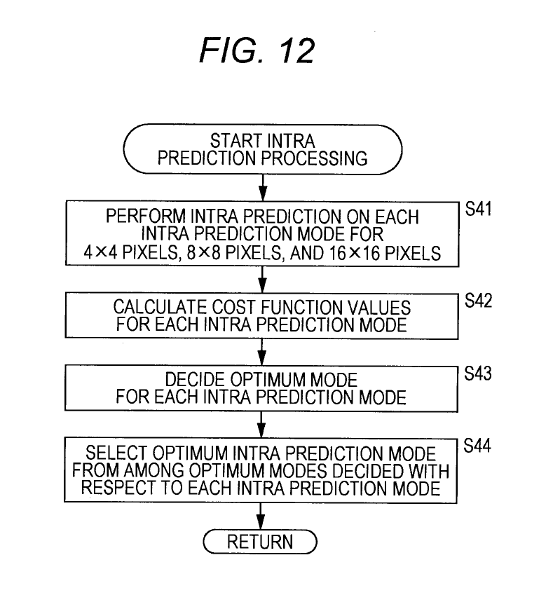

The details of the intra-prediction processing in step S21 will be described later with reference to FIG. 12. Through this processing, intra-prediction is carried out in all candidate intra-prediction modes, and cost function values for all the candidate intra-prediction modes are calculated. Based on the calculated cost function values, the optimum intra-prediction mode is selected, and the predicted image generated by intra-prediction in the optimum intra-prediction mode and the cost function value thereof are supplied to the predicted image selection unit 77.

When the image to be processed, which is supplied from the screen sorting buffer 62, is an image to be subjected to inter processing, the referenced image is read from the frame memory 72, and is supplied to the motion prediction/compensation unit 75 via the switch 73. Based on these images, in step S22, the motion prediction/compensation unit 75 performs inter motion prediction processing.

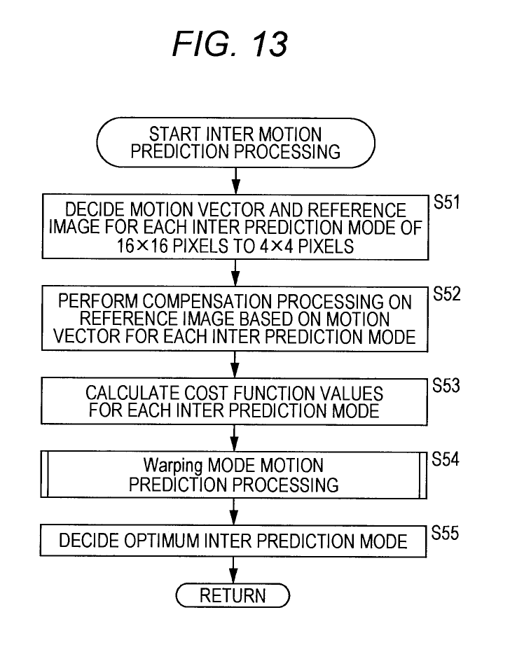

The inter motion prediction processing in step S22 will be described in detail later with reference to FIG. 13. Through this processing, motion search processing is carried out in all candidate inter-prediction modes including the Warping mode, and cost function values are calculated for all the candidate inter-prediction modes. Based on the calculated cost function values, the optimum inter-prediction mode is decided. The predicted image generated by the optimum inter-prediction mode and the cost function value thereof are supplied to the predicted image selection unit 77.

In step S23, the predicted image selection unit 77 decides one of the optimum intra-prediction mode and the optimum inter-prediction mode as the optimum prediction mode based on each cost function value output by the intra-prediction unit 74 and the motion prediction/compensation unit 75. The predicted image selection unit 77 selects the predicted image in the decided optimum prediction mode, and supplies the selected predicted image to each of the operation units 63 and 70. This predicted image is used for operations in steps S13 and S18 as described above.

Note that the selected information on the predicted image is supplied to the intra-prediction unit 74 or the motion prediction/compensation unit 75. When the predicted image in the optimum intra-prediction mode is selected, the intra-prediction unit 74 supplies the information (specifically, intra-prediction mode information) indicating the optimum intra-prediction mode to the lossless encoding unit 66.

When the predicted image in the optimum inter-prediction mode is selected, the motion prediction/compensation unit 75 outputs information indicating the optimum inter-prediction mode, and further outputs information according to the optimum inter-prediction mode, as needed, to the lossless encoding unit 66. Examples of the information according to the optimum inter-prediction mode include motion vector information and reference frame information.

In step S24, the lossless encoding unit 66 encodes the quantized transform coefficient output by the quantization unit 65. Specifically, a difference image is subjected to lossless encoding, such as variable-length encoding or arithmetic coding, and is compressed. At this time, the intra-prediction mode information from the intra-prediction unit 74, which is input to the lossless encoding unit 66 in step S21 described above, or the information according to the optimum inter-prediction mode from the motion prediction/compensation unit 75 in step S22, and the like are encoded and added to the header information.

For example, the information indicating the inter-prediction mode including the Warping mode is encoded for each macro block. The motion vector information and the reference frame information are encoded for each block of a target. In the Warping mode, only the motion vector information searched by the motion search unit 81 (specifically, the motion vector information on the corner blocks in the example shown in FIG. 8) is encoded and transmitted to the decoding side.

In step S25, the accumulation buffer 67 accumulates the difference image as a compressed image. The compressed image accumulated in the accumulation buffer 67 is appropriately read and transmitted to the decoding side through a transmission line.

In step S26, the rate control unit 78 controls the rate of the quantization operation of the quantization unit 65 so as to prevent occurrence of an overflow or an underflow, based on the compressed image accumulated in the accumulation buffer 67.

### [Explanation of Intra-prediction Processing]

Next, the intra-prediction processing in step S21 in FIG. 11 will be described with reference to the flowchart of FIG. 12. Note that in the example of FIG. 12, the case of the luminance signal will be described by way of example.

In step S41, the intra-prediction unit 74 performs intra-prediction for each intra-prediction mode of 4×4 pixels, 8×8 pixels, and 16×16 pixels.

The intra-prediction modes for a luminance signal include a prediction mode in units of blocks of 4×4 pixels and 8×8 pixels of nine types, and a prediction mode in units of macro blocks of 16×16 pixels of four types. The intra-prediction modes for a color-difference signal include a prediction mode in units of blocks of 8×8 pixels of four types. The intra-prediction modes for a color-difference signal can be set independently of the intra-prediction modes for a luminance signal. As for the intra-prediction modes for 4×4 pixels and 8×8 pixels of a luminance signal, one intra-prediction mode is defined for each block of the luminance signal of 4×4 pixels and 8×8 pixels. As for the intra-prediction mode for 16×16 pixels of a luminance signal and the intra-prediction modes for a color-difference signal, one prediction mode is defined for one macro block.

Specifically, the intra-prediction unit 74 reads pixels of a block to be processed from the frame memory 72, and performs intra-prediction by referring to the decoded image supplied through the switch 73. This intra-prediction processing is carried out in each intra-prediction mode, thereby generating a predicted image in each intra-prediction mode. Note that pixels that are not subjected to deblock filtering by the deblock filter 71 are used as the decoded pixels to be referred to.

In step S42, the intra-prediction unit 74 calculates cost function values for each intra-prediction mode of 4×4 pixels, 8×8 pixels, and 16×16 pixels. Herein, the cost function expressed as Formula (5) or Formula (6) is used as the cost function for obtaining the cost function values.

In step S43, the intra-prediction unit 74 decides each optimum mode for each intra-prediction mode of 4×4 pixels, 8×8 pixels, and 16×16 pixels. Specifically, as described above, in the case of each of the intra 4×4 prediction mode and intra 8×8 prediction mode, there are nine types of prediction modes, and in the case of the intra 16×16 prediction mode, there are four types of prediction modes. Accordingly, the intra-prediction unit 74 determines, based on the cost function values calculated in step S42, the optimum intra 4×4 prediction mode, the optimum intra 8×8 prediction mode, and the optimum intra 16×16 prediction mode from among those modes.

In step S44, the intra-prediction unit 74 selects the optimum intra-prediction mode based on the cost function value calculated in step S42, from among the optimum modes decided for each intra-prediction mode of 4×4 pixels, 8×8 pixels, and 16×16 pixels. Specifically, the intra-prediction unit 74 selects a mode having a minimum cost function value, as the optimum intra-prediction mode, from among the optimum modes decided for 4×4 pixels, 8×8 pixels, and 16×16 pixels. Then, the intra-prediction unit 74 supplies the predicted image generated in the optimum intra-prediction mode and the cost function value thereof to the predicted image selection unit 77.

### [Explanation of Inter Motion Prediction Processing]

Referring next to the flowchart of FIG. 13, the inter motion prediction processing in step S22 of FIG. 11 will be described.

In step S51, the motion search unit 81 decides a motion vector and a reference image for each of eight types of inter-prediction modes formed of 16×16 pixels to 4×4 pixels. Specifically, the motion vector and the reference image are decided for the blocks to be processed for each inter-prediction mode. The motion vector information is supplied to each of the motion compensation unit 82 and the optimum inter mode determination unit 84.

In step S52, the motion compensation unit 82 performs compensation processing on the reference image based on the motion vector decided in step S61 for each of eight types of inter-prediction modes formed of 16×16 pixels to 4×4 pixels. By this compensation processing, the predicted image for each inter-prediction mode is generated, and the generated predicted image is output to the cost function calculation unit 83.

In step S53, the cost function calculation unit 83 calculates the cost function value expressed as Formula (5) or Formula (6) described above for each of eight types of inter-prediction modes formed of 16×16 pixels to 4×4 pixels. The predicted image corresponding to the calculated cost function value is output to the optimum inter mode determination unit 84.

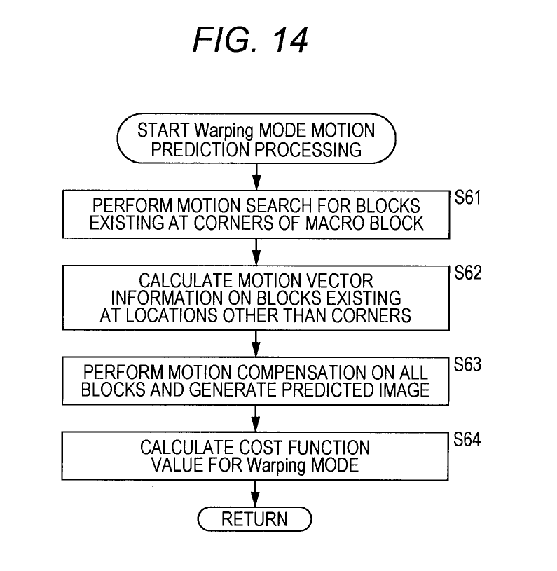

Further, the motion search unit 81 performs Warping mode motion prediction processing in step S54. This Warping mode motion prediction processing will be described in detail later with reference to FIG. 14. By this processing, motion vector information (searched motion vector information and Warping motion vector information) for the Warping mode is obtained. Based on the information, the predicted image is generated and the cost function value is calculated. The predicted image corresponding to the cost function value of the Warping mode is output to the optimum inter mode determination unit 84.

In step S55, the optimum inter mode determination unit 84 compares the inter-prediction mode calculated in step S53 with the cost function value for the Warping mode, and decides the prediction mode for giving a minimum value as the optimum inter-prediction mode. Then, the optimum inter mode determination unit 84 supplies the predicted image generated in the optimum inter-prediction mode and the cost function value thereof to the predicted image selection unit 77.

Note that in FIG. 13, the processing of the existing inter-prediction mode and the processing of the Warping mode have been described as separate steps for convenience of explanation to describe the Warping mode in detail. As a matter of course, the Warping mode may also be processed in the same step as other inter-prediction modes.

Referring next to the flowchart of FIG. 14, the Warping mode motion prediction processing in step S53 of FIG. 13 will be described. Note that the example shown in FIG. 14 shows the case where the motion vector information is searched and blocks that need to be sent to the decoding side correspond to the blocks at corners as in the example shown in FIG. 8.

In step S61, the motion search unit 81 performs motion search on only the blocks B₀₀, B₀₃, B₃₀, and B₃₃ existing at the corners of the macro block, by a method such as block matching. The searched motion vector information is supplied to the motion search unit 81. The motion search unit 81 also supplies the block addresses of blocks existing at locations other than the corners to the block address buffer 91.

In step S62, the motion vector calculation unit 92 calculates the motion vector information for the blocks existing at locations other than the corners. Specifically, the motion vector calculation unit 92 refers to the block address of the block of the block address buffer 91, and calculates the Warping motion vector information by Formula (9) described above by using the motion vector information on the blocks at the corners searched by the motion search unit 81. The calculated Warping motion vector information is supplied to the motion search unit 81.

The motion search unit 81 outputs the motion vector information on the blocks existing at the corners searched and the Warping motion vector information to each of the motion compensation unit 82 and the optimum inter mode determination unit 84.

In step S63, the motion compensation unit 82 performs motion compensation on the reference image from the frame memory 72 for all the blocks in the macro block by using the motion vector information on the blocks existing at the corners searched and the Warping motion vector information, thereby generating the predicted image. The generated predicted image is output to the cost function calculation unit 83.

In step S64, the cost function calculation unit 83 calculates the cost function value expressed as Formula (5) or Formula (6) described above for the Warping mode. The predicted image corresponding to the calculated cost function value of the Warping mode is output to the optimum inter mode determination unit 84.

As described above, motion search and motion compensation are carried out only on the blocks existing at the corners of the macro block in the method shown in FIG. 14. For the other blocks, motion search is not carried out, and only the motion compensation is carried out.

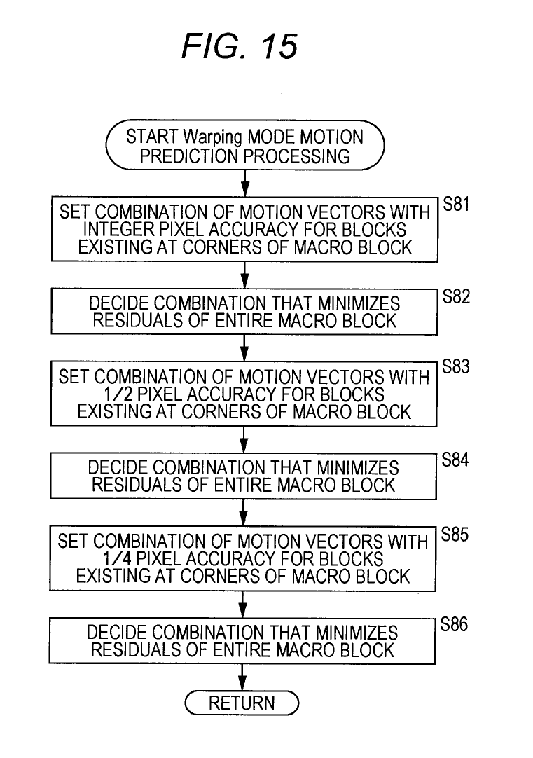

Referring next to flowchart of FIG. 15, another example of the Warping mode motion prediction processing in step S53 of FIG. 13 will be described. Note that also the example shown in FIG. 15 illustrates the case where the motion vector information is searched and the blocks at the corners need to be sent to the decoding side as in the example shown in FIG. 8.

In the example shown in FIG. 15, as described above with reference to FIG. 5, the motion search processing with an integer pixel accuracy is first carried out in steps S81 and S82, and the motion search processing with the ½ pixel accuracy is then carried out in steps S83 and S84. Lastly, in steps S85 and S86, the motion search with the ¼ pixel accuracy is carried out. Note that the motion vector information is originally two-dimensional data having a horizontal-direction component and a vertical-direction component. However, the motion vector information will be described below as one-dimensional data for convenience of explanation.

Assume herein that R is an integer and −R≦x<R is designated in units of integer pixels within the search range of motion vectors for each of the blocks of B₀₀, B₀₃, B₃₀, and B₃₃ shown in FIG. 8.

First, in step S81, the motion search unit 81 of the motion prediction/compensation unit 75 sets a combination of motion vectors with an integer pixel accuracy for the blocks existing at the corners of the macro block. In the motion search in units of integer pixels, there are (2R)⁴ combinations in total of motion vectors for the blocks B₀₀, B₀₃, B₃₀, and B₃₃.

In step S82, the motion prediction/compensation unit 75 decides a combination that minimizes the residual in the entire macro block. Specifically, the motion vector calculation unit 92 also calculates the motion vectors for the blocks B₁₀, B₂₃, . . . to which no motion vector is transmitted, by all (2R)⁴ combinations of motion vectors, and the motion compensation unit 82 generates all predicted images.

On the other hand, the cost function calculation unit 83 calculates cost function values for the entire macro block including prediction residuals for these blocks, and the optimum inter mode determination unit 84 decides combinations that minimize the cost function values. The combinations herein decided are respectively referred to as Intmv₀₀, Intmv3₀, Intmv₀₃, and Intmv₃₃.

Next, in step S83, the motion search unit 81 sets a combination of motion vectors with the ½ pixel accuracy for the blocks existing at the corners of the macro block. Specifically, Intmvᵢⱼ (i, j=0 or 3) and Intmvᵢⱼ±0.5 are candidates for the blocks B₀₀, B₀₃, B₃₀, and B₃₃. That is, 3⁴ combinations are tried in this case.

In step S84, the motion prediction/compensation unit 75 decides combinations that minimize the residuals of the entire macro block. Specifically, the motion vector calculation unit 92 also calculates the motion vectors for the blocks B₁₀, B₂₃, . . . to which no motion vector is transmitted, by all 3⁴ combinations of motion vectors, and the motion compensation unit 82 generates all predicted images.

On the other hand, the cost function calculation unit 83 calculates cost function values of the entire macro block including the prediction residuals for these blocks, and the optimum inter mode determination unit 84 decides combinations that minimize these cost function value. The combinations herein decided are respectively referred to as halfmv₀₀, halfmv3₀, halfmv₀₃, and halfmv₃₃.

Furthermore, in step S85, the motion search unit 81 sets a combination of motion vectors with the ¼ pixel accuracy for the blocks existing at the corners of the macro block. Specifically, halfmvᵢⱼ (i, j=0 or 3) and Intmvᵢⱼ±0.25 are candidates for the blocks B₀₀, B₀₃, B₃₀, and B₃₃. That is, 3⁴ combinations are tried also in this case.

In step S86, the motion prediction/compensation unit 75 decides combinations that minimize the residuals of the entire macro block. Specifically, the motion vector calculation unit 92 also calculates the motion vectors for the blocks B₁₀, B₂₃, . . . to which no motion vector is transmitted, by all 3⁴ combinations of motion vectors, and the motion compensation unit 82 generates all predicted images.

On the other hand, the cost function calculation unit 83 calculates cost function values of the entire macro block including the prediction residuals for these blocks, and the optimum inter mode determination unit 84 decides combinations that minimize these cost function values. The decided combinations are respectively referred to as Quartermv₀₀, Quartermv3₀, Quartermv₀₃, and Quartermv₃₃. At this time, assuming that the minimum cost function value is the cost function value of the Warping mode, the cost function value is compared with the cost function value of another prediction mode in step S55 of FIG. 13 described above.

As described above, in the method shown in FIG. 15, the residual signal is calculated for combinations of motion vectors with any accuracy within the search range for the blocks existing at the corners of the macro block, and a combination of motion vectors that minimizes the cost function value is obtained using the calculated residual signal, thereby searching the motion vectors existing at the corners. Accordingly, when the two Warping mode motion prediction methods described above with reference to FIGS. 14 and 15 are compared, the computation amount in the method shown in FIG. 14 is lower, but a higher encoding efficiency can be achieved in the method shown in FIG. 15.

The encoded compressed image is transmitted through a predetermined transmission line and is decoded by the image decoding apparatus.

### [Configuration Example of Image Decoding Apparatus]

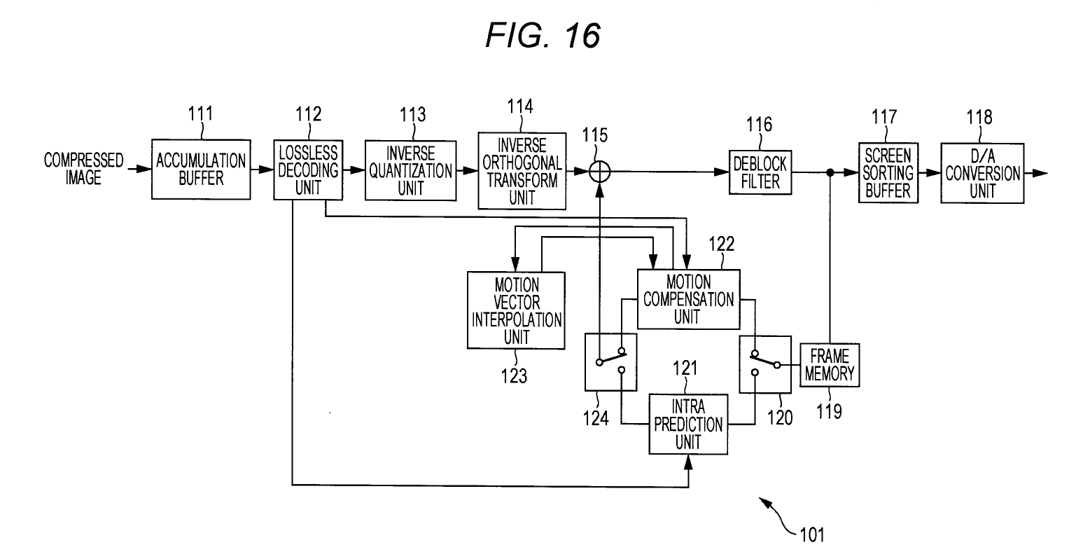

FIG. 16 shows a configuration according to an exemplary embodiment of the image decoding apparatus as the image processing apparatus to which the present invention is applied.

An image decoding apparatus 101 includes an accumulation buffer 111, a lossless decoding unit 112, an inverse quantization unit 113, an inverse orthogonal transform unit 114, an operation unit 115, a deblock filter 116, a screen sorting buffer 117, a D/A conversion unit 118, a frame memory 119, a switch 120, an intra-prediction unit 121, a motion compensation unit 122, a motion vector interpolation unit 123, and a switch 124.

The accumulation buffer 111 stores the transmitted compressed image. The lossless decoding unit 112 decodes the information, which is supplied from the accumulation buffer 111 and encoded by the lossless encoding unit 66 shown in FIG. 3, in a system corresponding to the encoding system of the lossless encoding unit 66.

The inverse quantization unit 113 performs inverse quantization on the image decoded by the lossless decoding unit 112, in a system corresponding to the quantization system of the quantization unit 65 shown in FIG. 3. The inverse orthogonal transform unit 114 performs inverse orthogonal transform on the output of the inverse quantization unit 113 in the system corresponding to the orthogonal transform system of the orthogonal transform unit 64 shown in FIG. 3.

The output subjected to the inverse orthogonal transform is added to the predicted image supplied from the switch 124 by the operation unit 115 and is decoded. After removing a block distortion from the decoded image, the deblock filter 116 supplies and accumulates the image into the frame memory 119, and outputs the image to the screen sorting buffer 117.

The screen sorting buffer 117 sorts the images. Specifically, the frames, which are sorted in the order of encoding by the screen sorting buffer 62 shown in FIG. 3, are sorted in the order of original display. The D/A conversion unit 118 performs D/A conversion on the image supplied from the screen sorting buffer 117, and outputs and displays the image on a display which is not shown.

The switch 120 reads the image to be subjected to inter processing and the image to be referred to, from the frame memory 119, and outputs the images to the motion compensation unit 122. At the same time, the switch 120 reads the image used for intra-prediction from the frame memory 119, and supplies the image to the intra-prediction unit 121.

The intra-prediction unit 121 is supplied with the information indicating the intra-prediction mode obtained by decoding the header information from the lossless decoding unit 112. The intra-prediction unit 121 generates a predicted image based on this information, and outputs the generated predicted image to the switch 124.

The motion compensation unit 122 is supplied with the inter-prediction mode information, the motion vector information, the reference frame information, and the like, among the information obtained by decoding the header information, from the lossless decoding unit 112. The inter-prediction mode information is transmitted for each macro block. The motion vector information and the reference frame information are transmitted for each target block.

The motion compensation unit 122 generates a pixel value of a predicted image for a target block in the prediction mode indicated by the inter-prediction mode information supplied from the lossless decoding unit 112. When the prediction mode indicated by the inter-prediction mode information is the Warping mode, however, only a part of the motion vectors included in the macro block is supplied from the lossless decoding unit 112 in the motion compensation unit 122. These motion vectors are supplied to the motion vector interpolation unit 123. In this case, the motion compensation unit 122 performs compensation processing on the reference image by using the motion vectors of the searched part of blocks and the motion vectors of the remaining blocks calculated by the motion vector interpolation unit 123, and generates a predicted image.

The motion vector interpolation unit 123 is supplied with the motion vector information on the searched part of blocks and the block address of the corresponding block within the macro block from the motion compensation unit 122. The motion vector interpolation unit 123 refers to the supplied block address, and calculates the motion vector information on the remaining blocks in the macro block by using the motion vector information on a part of blocks. The motion vector interpolation unit 123 supplies the calculated motion vector information on the remaining blocks to the motion compensation unit 122.

The switch 124 selects the predicted image generated by the motion compensation unit 122 or the intra-prediction unit 121, and supplies the predicted image to the operation unit 115.

Note that in the motion prediction/compensation unit 75 and the motion vector interpolation unit 76 shown in FIG. 3, it is necessary to generate predicted images and calculate cost function values for all candidate modes including the Warping mode, and to determine the mode. On the other hand, in the motion compensation unit 122 and the motion vector interpolation unit 123 shown in FIG. 16, the mode information and the motion vector information for the blocks are received from the header of the compressed image, and only the motion compensation processing is carried out using the information.

### [Configuration Examples of Motion Prediction/Compensation Unit and Adaptive Interpolation Filter Setting Unit]

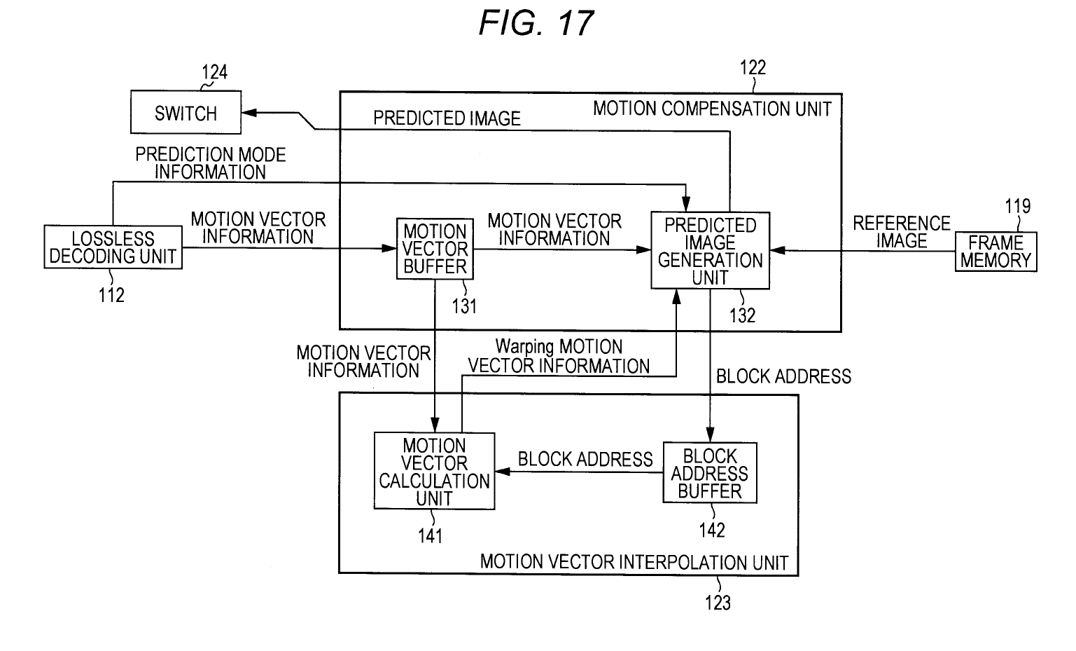

FIG. 17 is a block diagram showing detailed configuration examples of the motion compensation unit 122 and the motion vector interpolation unit 123. Note that in FIG. 17, the switch 120 shown in FIG. 16 is omitted.

In the example shown in FIG. 17, the motion compensation unit 122 includes a motion vector buffer 131 and a predicted image generation unit 132.

The motion vector interpolation unit 123 includes a motion vector calculation unit 141 and a block address buffer 142.

The motion vector buffer 131 accumulates the motion vector information for each block from the lossless decoding unit 112, and supplies the motion vector information to each of the predicted image generation unit 132 and the motion vector calculation unit 141.

The predicted image generation unit 132 is supplied with the prediction mode information from the lossless decoding unit 112, and is supplied with the motion vector information from the motion vector buffer 131. When the prediction mode indicated by the prediction mode information is the Warping mode, the predicted image generation unit 132 supplies the block address of a block whose motion vector information is not sent from the encoding side, for example, a block other than those at the corners of the macro block, to the block address buffer 142. The predicted image generation unit 132 performs compensation processing on the reference image of the frame memory 119 by using the motion vector information on the corners of the macro block supplied from the motion vector buffer 131, and the Warping motion vector information calculated by the motion vector calculation unit 141 of the block other than the blocks, thereby generating a predicted image. The generated predicted image is output to the switch 124.

The motion vector calculation unit 141 calculates the Warping motion vector information in the block of the block address from the block address buffer 142 by using the above-mentioned Formula (9), and supplies the calculated Warping motion vector information to the predicted image generation unit 132.

The block address buffer 142 receives the block address of a block other than those at the corners of the macro block from the predicted image generation unit 132. The block address is supplied to the motion vector calculation unit 141.

### [Explanation of Decoding Processing of Image Decoding Apparatus]

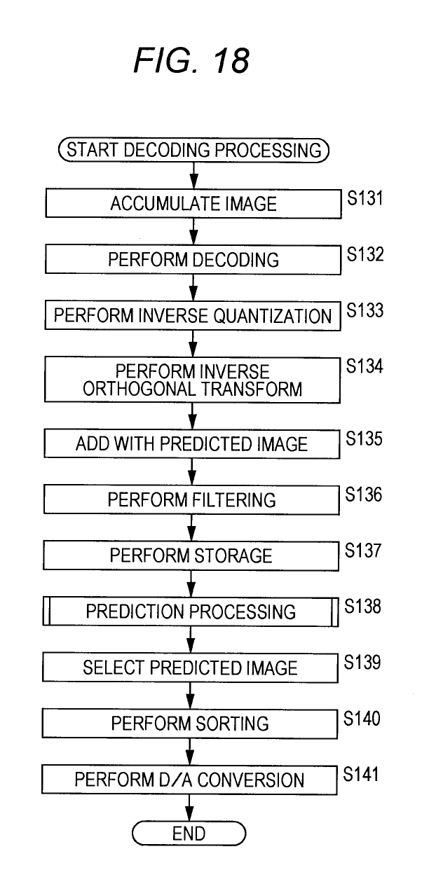

Referring next to the flowchart of FIG. 18, the decoding processing executed by the image decoding apparatus 101 will be described.

In step S131, the accumulation buffer 111 accumulates the transmitted image. In step S132, the lossless decoding unit 112 decodes the compressed image supplied from the accumulation buffer 111. Specifically, the I picture, P picture, and B picture, which are encoded by the lossless encoding unit 66 shown in FIG. 3, are decoded.

At this time, the motion vector information, reference frame information, prediction mode information (information indicating the intra-prediction mode or the inter-prediction mode), and the like are also decoded.

Specifically, when the prediction mode information indicates the intra-prediction mode information, the prediction mode information is supplied to the intra-prediction unit 121. When the prediction mode information indicates the inter-prediction mode information, the motion vector information corresponding to the prediction mode information and the reference frame information are supplied to the motion compensation unit 122.

In step S133, the inverse quantization unit 113 performs inverse quantization on the transform coefficient decoded by the lossless decoding unit 112 based on the feature corresponding to the feature of the quantization unit 65 shown in FIG. 3. In step S134, the inverse orthogonal transform unit 114 performs the inverse orthogonal transform on the transform coefficient subjected to the inversion quantization by the inverse quantization unit 113, based on the feature corresponding to the feature of the orthogonal transform unit 64 shown in FIG. 3. As a result, the difference information corresponding to the input of the orthogonal transform unit 64 (output of the operation unit 63) shown in FIG. 3 is decoded.

In step S135, the operation unit 115 adds the predicted image, which is selected in the processing in step S139 described later and which is input through the switch 124, to the difference information. Thus, the original image is decoded. In step S136, the deblock filter 116 filters the image output by the operation unit 115, thereby removing a block distortion. In step S137, the frame memory 119 stores the filtered image.

In step S138, the intra-prediction unit 121 or the motion compensation unit 122 performs prediction processing on each image so as to correspond to the prediction mode information supplied from the lossless decoding unit 112.

Specifically, when the intra-prediction mode information is supplied from the lossless decoding unit 112, the intra-prediction unit 121 performs intra-prediction processing of the intra-prediction mode. When the inter-prediction mode information is supplied from the lossless decoding unit 112, the motion compensation unit 122 performs motion prediction/compensation processing of the inter-prediction mode. Note that when the inter-prediction mode corresponds to the Warping mode, the motion compensation unit 122 generates a pixel value of a predicted image for a target block by using not only the motion vector from the lossless decoding unit 112 but also the motion vector calculated by the motion vector interpolation unit 123.

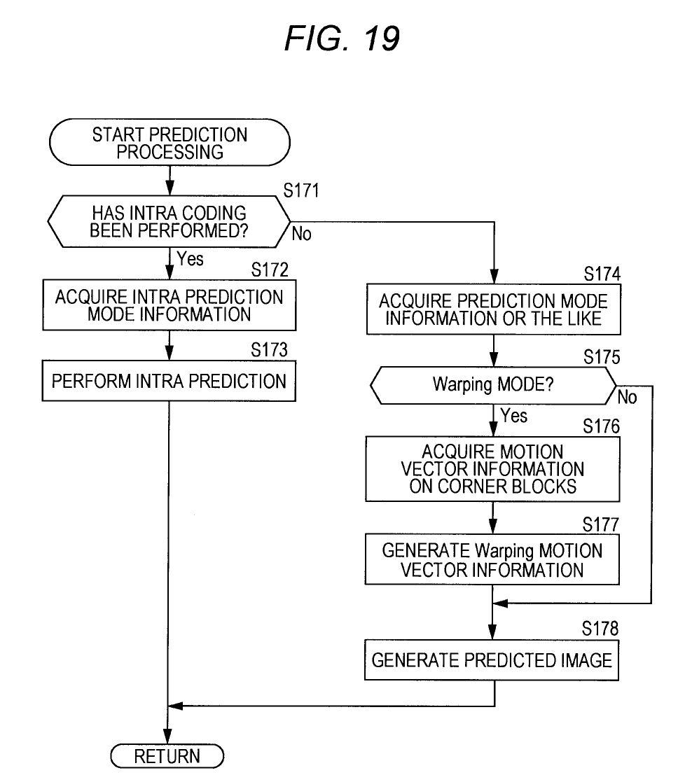

The prediction processing in step S138 will be described in detail later with reference to FIG. 19. Through the processing, the predicted image generated by the intra-prediction unit 121 or the predicted image generated by the motion compensation unit 122 is supplied to the switch 124.

In step S139, the switch 124 selects the predicted image. Specifically, the predicted image generated by the intra-prediction unit 121 or the predicted image generated by the motion compensation unit 122 is supplied. Accordingly, the supplied predicted image is selected and supplied to the operation unit 115, and is added to the output of the inverse orthogonal transform unit 114 in step S135 as described above.

In step S140, the screen sorting buffer 117 performs sorting. Specifically, the frames sorted for the encoding by the screen sorting buffer 62 of the image encoding apparatus 51 are sorted in the original order of display.

In step S141, the D/A conversion unit 118 performs D/A conversion on the image from the screen sorting buffer 117. This image is output to a display, which is not shown, and the image is displayed.

### [Explanation of Prediction Processing of Image Decoding Apparatus]

Next, the prediction processing in step S138 of FIG. 18 will be described with reference to the flowchart of FIG. 19.

In step S171, the intra-prediction unit 121 determines whether the target block has been subjected to intra encoding. When the intra-prediction mode information is supplied from the lossless decoding unit 112 to the intra-prediction unit 121, the intra-prediction unit 121 determines in step S171 that the target block has been subjected to intra encoding, and the processing proceeds to step S172.

The intra-prediction unit 121 obtains intra-prediction mode information in step S172 and performs intra-prediction in step S173.

Specifically, when the image to be processed is an image to be subjected to intra processing, a necessary image is read from the frame memory 119 and is supplied to the intra-prediction unit 121 through the switch 120. In step S173, the intra-prediction unit 121 performs intra-prediction in accordance with the intra-prediction mode information obtained in step S172, and generates a predicted image. The generated predicted image is output to the switch 124.

On the other hand, when it is determined in step S171 that the intra encoding has not been performed, the processing proceeds to step S174.

When the image to be processed is an image to be subjected to inter processing, the inter-prediction mode information, the reference frame information, and the motion vector information are supplied from the lossless decoding unit 112 to the motion compensation unit 122.

In step S174, the motion compensation unit 122 obtains prediction mode information and the like. Specifically, inter-prediction mode information, reference frame information, and motion vector information are obtained. The obtained motion vector information is accumulated in the motion vector buffer 131.

In step S175, the predicted image generation unit 132 of the motion compensation unit 122 determines whether the prediction mode indicated by the prediction mode information is the Warping mode.

When it is determined in step S175 that the prediction mode is the Warping mode, the block address of a block other than those at the corners of the macro block is supplied to the motion vector calculation unit 141 via the block address buffer 142 from the predicted image generation unit 132.

On the other hand, in step S176, the motion vector calculation unit 141 obtains motion vector information on the corner blocks from the motion vector buffer 131. In step S177, the motion vector calculation unit 141 calculates the Warping motion vector information on the block of the block address from the block address buffer 142 by the above-mentioned Formula (9) using the motion vector information on the corner blocks. The calculated Warping motion vector information is supplied to the predicted image generation unit 132.

In this case, in step S178, the predicted image generation unit 132 performs compensation processing on the reference image from the frame memory 119 by using the motion vector information from the motion vector buffer 131 and the Warping motion vector information from the motion vector calculation unit 141, and generates a predicted image.

On the other hand, when it is determined in step S175 that the prediction mode is not the Warping mode, steps S176 and S177 are skipped. In step S178, the predicted image generation unit 132 performs compensation processing on the reference image from the frame memory 119 by using the motion vector information from the motion vector buffer 131 in the prediction mode indicated by the prediction mode information, and generates a predicted image. The generated predicted image is output to the switch 124.

As described above, in the image encoding apparatus 51 and the image decoding apparatus 101, the Warping mode is provided as an inter-prediction mode.

In the image encoding apparatus 51, only the motion vectors of blocks in a part (corners in the above example) of the macro block are searched as the Warping mode, and only the searched motion vectors are transmitted to the decoding side.

This enables elimination of an overhead in the compressed image to be sent to the decoding side.

In the image encoding apparatus 51 and the image decoding apparatus 101, the motion vector of a part of blocks is used as the Warping mode, and the motion vectors of other blocks are generated to thereby generate a predicted image using the motion vectors.

Accordingly, the motion vector information, which is not a single, can be used within the block, which achieves an improvement in efficiency due to motion prediction.

Further, in the Warping mode, the interpolation processing for motion vectors is performed in units of blocks, thereby making it possible to prevent deterioration in access efficiency to the frame memory.

Note that in the case of a B picture, each of the image encoding apparatus 51 and the image decoding apparatus 101 generates the motion vector information and performs motion prediction compensation processing for each of List 0 prediction and List 1 prediction, for example, by the method shown in FIG. 8 or Formula (9).

Though the H.264/AVC system is mainly used as the encoding system in the above example, the present invention is not limited thereto. The present invention is also applicable to another encoding system/decoding system in which a frame is segmented into a plurality of motion compensation blocks and encoding processing is performed by allocating motion vector information to each block.

Incidentally, the standardization of an encoding system called HEVC (High Efficiency Video Coding) has been currently developed by JCTVC (Joint Collaboration Team-Video Coding), which is a joint standardization organization of ITU-T and ISO/IEC, for the purpose of further improving the encoding efficiency compared to AVC. As of September, 2010, “Test Model under Consideration”, (JCTVC-B205), has been issued as a draft.

The coding unit specified in the HEVC encoding system will be described.

The coding unit (CU) is also called a coding tree block (CTB), and plays the same role as macro blocks in AVC. The latter is fixed to the size of 16×16 pixels, while the size of the former is not fixed and is designated in image compression information in each sequence.

In particular, CU having a maximum size is called LCU (largest coding unit), and CU having a minimum size is called SCU (smallest coding unit). These sizes are designated in a set of sequence parameters included in the image compression information, but are limited to the size represented by a power of 2 in a square.

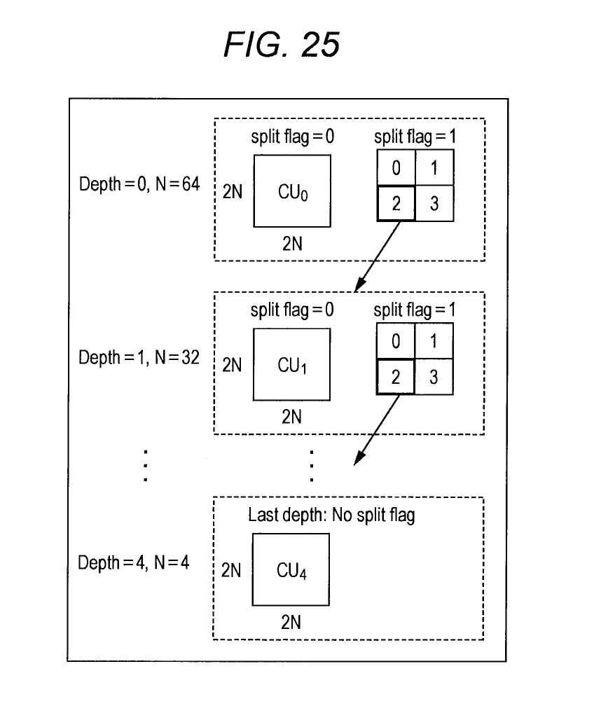

FIG. 25 shows an exemplary coding unit defined in the HEVC. In the example shown in the figure, the size of the LCU is 128, and the maximum hierarchy depth is 5. The CU having a size of 2N×2N is divided into CUs having a size of N×N, which is a next lower hierarchy, when the value of split_flag indicates 1.

Further, the CU is divided into prediction units (PUs), which are the units of intra- or inter-prediction, and is further divided into transform units (TUs), which are the units of orthogonal transform. Further, prediction processing and orthogonal transform processing are carried out. Currently, in the HEVC, not only 4×4 and 8×8 orthogonal transform, but also 16×16 and 32×32 orthogonal transform can be used.

Herein, the blocks and macro blocks include the concepts of the coding unit (CU), the prediction unit (PU), and the transform unit (TU) as described above, and are not limited to the blocks with a fixed size.

Like MPEG and H.26x, for example, the present invention can be applied to an image encoding apparatus and an image decoding apparatus for use in receiving image information (bit stream) compressed by orthogonal transform, such as discrete cosine transform, and motion compensation, via network media such as satellite broadcasting, cable television, the Internet, and a portable phone set. The present invention can also be applied to an image encoding apparatus and an image decoding apparatus for use in processing on storage media such as an optical disk, a magnetic disk, and a flash memory. Furthermore, the present invention can also be applied to a motion prediction/compensation device included in the image encoding apparatus and the image decoding apparatus.

The above-mentioned series of processing can be executed by hardware or software. In the case of executing the series of processing by software, a program constituting the software is installed in a computer. Examples of the computer include a computer incorporated in a dedicated hardware, and a general-purpose personal computer capable of executing various functions by installing various programs.

### [Configuration Example of Personal Computer]

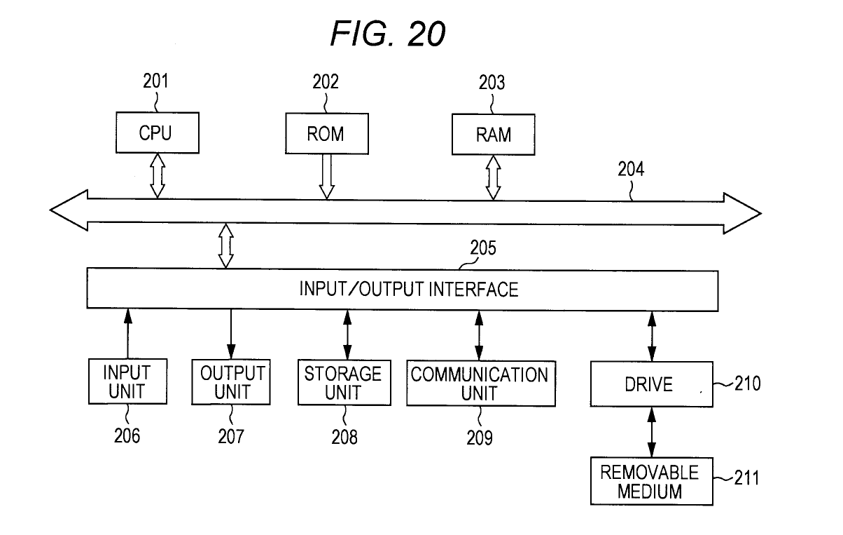

FIG. 20 is a block diagram showing a configuration example of a hardware of a computer for executing a series of processing described above using a program.

In the computer, a CPU (Central Processing Unit) 201, a ROM (Read Only Memory) 202, and a RAM (Random Access Memory) 203 are interconnected via a bus 204.

The bus 204 is also connected to an input/output interface 205. The input/output interface 205 is connected to an input unit 206, an output unit 207, a storage unit 208, a communication unit 209, and a drive 210.

The input unit 206 includes a keyboard, a mouse, and a microphone, for example. The output unit 207 includes a display and a speaker, for example. The storage unit 208 includes a hard disk and a non-volatile memory, for example. The communication unit 209 includes a network interface, for example. The drive 210 drives a removable medium 211 such as a magnetic disk, an optical disk, a magneto-optical disk, or a semiconductor memory.

In the computer configured as described above, the CPU 201 loads, into the RAM 203, and executes the program stored in the storage unit 208, for example, through the input/output interface 205 and the bus 204, thereby performing the above-mentioned series of processing.

The program executed by the computer (CPU 201) can be provided in a form stored in the removable medium 211 such as a package medium, for example. The program can also be provided via wired or wireless transmission media such as a local area network, the Internet, or digital broadcasting.

In the computer, the program can be installed in the storage unit 208 via the input/output interface 205 by mounting the removable medium 211 in the drive 210. The program can be received by the communication unit 209 via wired or wireless transmission media and can be installed in the storage unit 208. Additionally, the program can be preliminarily installed in the ROM 202 and the storage unit 208.

Note that the program executed by the computer may be a program for executing processing in time series according to the sequence herein described, or may be a program for executing processing in parallel or at a necessary timing when a call is made, for example.

Embodiments of the present invention are not limited to the above embodiments, but can be modified in various manners without departing from the scope of the present invention.

For example, the image encoding apparatus 51 and the image decoding apparatus 101 described above can be applied to any electronic equipment. The examples thereof will be described below.

### [Configuration Example of Television Receiver]

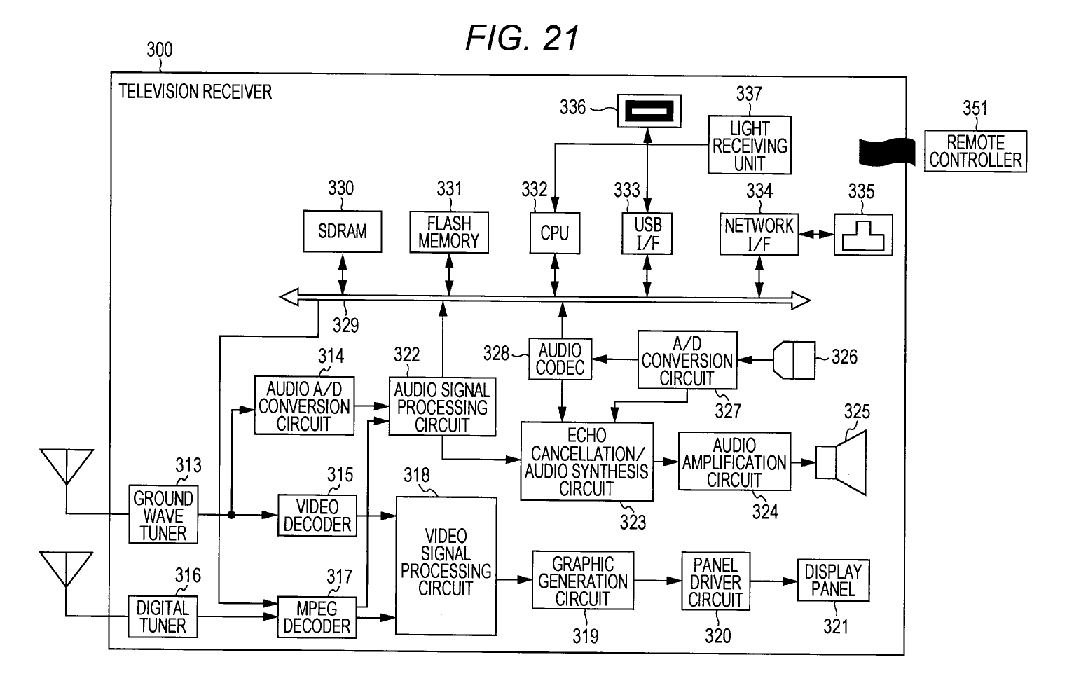

FIG. 21 is a block diagram showing an example of a main configuration of a television receiver using the image decoding apparatus to which the present invention is applied.

The television receiver 300 shown in FIG. 21 includes a ground wave tuner 313, a video decoder 315, a video signal processing circuit 318, a graphic generation circuit 319, a panel driver circuit 320, and a display panel 321.

The ground wave tuner 313 receives and demodulates broadcasting signals for terrestrial analog broadcasting via an antenna, and obtains video signals. Further, the ground wave tuner 313 supplies the video signals to the video decoder 315. The video decoder 315 performs decoding processing on the video signals supplied from the ground wave tuner 313, and supplies the obtained digital component signals to the video signal processing circuit 318.

The video signal processing circuit 318 performs predetermined processing, such as noise removal, on the video data supplied from the video decoder 315, and supplies the obtained video data to the graphic generation circuit 319.

The graphic generation circuit 319 generates video data for broadcast programs displayed on the display panel 321, image data by processing based on an application supplied via a network, and the like, and supplies the generated video data and image data to the panel driver circuit 320. The graphic generation circuit 319 also performs processing, as needed, such as generation of video data (graphics) to display the screen used by a user to select items, for example, and supply of the video data obtained by superimposing the screen on the video data for broadcast programs to the panel driver circuit 320.

The panel driver circuit 320 drives the display panel 321 based on the data supplied from the graphic generation circuit 319, and displays videos for broadcast programs and various screens described above on the display panel 321.

The display panel 321 includes an LCD (Liquid Crystal Display), for example, and displays videos for broadcast programs under the control of the panel driver circuit 320.

The television receiver 300 also includes an audio A/D (Analog/Digital) conversion circuit 314, an audio signal processing circuit 322, an echo cancellation/audio synthesis circuit 323, an audio amplification circuit 324, and a speaker 325.

The ground wave tuner 313 demodulates the received broadcasting signals and obtains video signals as well as audio signals. The ground wave tuner 313 supplies the obtained audio signals to the audio A/D conversion circuit 314.

The audio A/D conversion circuit 314 performs A/D conversion processing on the audio signals supplied from the ground wave tuner 313, and supplies the obtained digital audio signals to the audio signal processing circuit 322.

The audio signal processing circuit 322 performs predetermined processing, such as noise removal, on the audio data supplied from the audio A/D conversion circuit 314, and supplies the obtained audio data to the echo cancellation/audio synthesis circuit 323.

The echo cancellation/audio synthesis circuit 323 supplies the audio data supplied from the audio signal processing circuit 322 to the audio amplification circuit 324.

The audio amplification circuit 324 performs D/A conversion processing on the audio data supplied from the echo cancellation/audio synthesis circuit 323, and performs amplification processing. Further, after the audio data is adjusted to a predetermined volume, the audio is output from the speaker 325.

The television receiver 300 also includes a digital tuner 316 and an MPEG decoder 317.

The digital tuner 316 receives and demodulates broadcasting signals for digital broadcasting (digital terrestrial broadcasting, BS (Broadcasting Satellite)/CS (Communications Satellite) digital broadcasting) via an antenna, and obtains MPEG-TS (Moving Picture Experts Group-Transport Stream) to be supplied to the MPEG decoder 317.

The MPEG decoder 317 releases the scrambling performed on the MPEG-TS supplied from the digital tuner 316, and extracts a stream containing data for a broadcast program to be reproduced (to be viewed). The MPEG decoder 317 decodes audio packets forming the extracted stream, and supplies the obtained audio data to the audio signal processing circuit 322. Further, the MPEG decoder 317 decodes video packets forming the stream, and supplies the obtained video data to the video signal processing circuit 318. The MPEG decoder 317 also supplies the EPG (Electronic Program Guide) data extracted from the MPEG-TS to a CPU 332 via a path which is not shown.

The television receiver 300 uses the image decoding apparatus 101 described above, as the MPEG decoder 317 for decoding the video packets. Accordingly, the MPEG decoder 317 can achieve an improvement in efficiency due to motion prediction, as in the case of the image decoding apparatus 101.

The video data supplied from the MPEG decoder 317 is subjected to predetermined processing in the video signal processing circuit 318, as in the case of the video data supplied from the video decoder 315. Then, generated video data or the like is superimposed as needed on the video data subjected to the predetermined processing in the graphic generation circuit 319, and the video data is supplied to the display panel 321 through the panel driver circuit 320, so that the image thereof is displayed.

The audio data supplied from the MPEG decoder 317 is subjected to predetermined processing in the audio signal processing circuit 322, as in the case of the audio data supplied from the audio A/D conversion circuit 314. Then, the audio data subjected to the predetermined processing is supplied to the audio amplification circuit 324 through the echo cancellation/audio synthesis circuit 323, and is subjected to D/A conversion processing or amplification processing. As a result, the audio adjusted to a predetermined volume is output from the speaker 325.

The television receiver 300 also includes a microphone 326 and an A/D conversion circuit 327.

The A/D conversion circuit 327 receives the user audio signal captured by the microphone 326 provided in the television receiver 300 for audio conversation. The A/D conversion circuit 327 performs A/D conversion processing on the received audio signal, and supplies the obtained digital audio data to the echo cancellation/audio synthesis circuit 323.

The echo cancellation/audio synthesis circuit 323 performs echo cancellation for audio data of a user A, when the audio data of the user (user A) of the television receiver 300 is supplied from the A/D conversion circuit 327. The echo cancellation/audio synthesis circuit 323 causes the audio data obtained by synthesizing the audio data with another audio data, for example, to be output from the speaker 325 through the audio amplification circuit 324, after the echo cancellation.

The television receiver 300 also includes an audio codec 328, an internal bus 329, an SDRAM (Synchronous Dynamic Random Access Memory) 330, a flash memory 331, the CPU 332, a USB (Universal Serial Bus) I/F 333, and a network I/F 334.

The A/D conversion circuit 327 receives a user audio signal captured by the microphone 326 provided in the television receiver 300 for audio conversation. The A/D conversion circuit 327 performs A/D conversion processing on the received audio signal, and supplies the obtained digital audio data to the audio codec 328.

The audio codec 328 converts the audio data supplied from the A/D conversion circuit 327 into data of a predetermined format to be transmitted via a network, and supplies the data to the network I/F 334 via the internal bus 329.

The network I/F 334 is connected to the network via a cable mounted to a network terminal 335. The network I/F 334 transmits the audio data supplied from the audio codec 328 to another apparatus connected to the network, for example. The network I/F 334 receives the audio data transmitted from another apparatus connected via the network, through the network terminal 335, and supplies the audio data to the audio codec 328 via the internal bus 329.

The audio codec 328 converts the audio data supplied from the network I/F 334 into data of the predetermined format, and supplies the data to the echo cancellation/audio synthesis circuit 323.

The echo cancellation/audio synthesis circuit 323 performs echo cancellation for the audio data supplied from the audio codec 328, and causes the audio data obtained by synthesizing the audio data with another audio data, for example, to be output from the speaker 325 through the audio amplification circuit 324.

The SDRAM 330 stores various data necessary for the CPU 332 to perform processing.

The flash memory 331 stores a program executed by the CPU 332. The program stored in the flash memory 331 is read by the CPU 332 at a predetermined timing upon activation of the television receiver 300, for example. The flash memory 331 also stores the EPG data obtained via digital broadcasting, and the data obtained from a predetermined server via a network, for example.

For example, the flash memory 331 stores the MPEG-TS containing the content data obtained from the predetermined server via the network under the control of the CPU 332. The flash memory 331 supplies the MPEG-TS to the MPEG decoder 317 via the internal bus 329 under the control of the CPU 332, for example.

The MPEG decoder 317 processes the MPEG-TS, as in the case of the MPEG-TS supplied from the digital tuner 316. The television receiver 300 can receive content data formed of a video, an audio, or the like via a network, decode the data using the MPEG decoder 317, and display the video or output the audio.

The television receiver 300 also includes a light receiving unit 337 that receives infrared signal light transmitted from a remote controller 351.

The light receiving unit 337 receives infrared rays from the remote controller 351, and outputs a control code representing the contents of user operation obtained through demodulation to the CPU 332.

The CPU 332 executes the program stored in the flash memory 331, and controls the overall operation of the television receiver 300 according to the control code supplied from the light receiving unit 337. Each part of the CPU 332 and the television receiver 300 is connected via a path which is not shown.

The USB I/F 333 transmits and receives data to and from an external device of the television receiver 300, which is connected via a USB cable mounted to the USB terminal 336. The network I/F 334 is connected to the network via a cable mounted to the network terminal 335, and transmits and receives data other than audio data to and from various devices connected to the network.

The television receiver 300 uses the image decoding apparatus 101 as the MPEG decoder 317, thereby making it possible to improve the encoding efficiency. As a result, the television receiver 300 can obtain a higher-definition decoded image from the broadcasting signal received via an antenna, or the content data obtained via a network, and can display the image.

### [Configuration Example of Portable Phone Set]

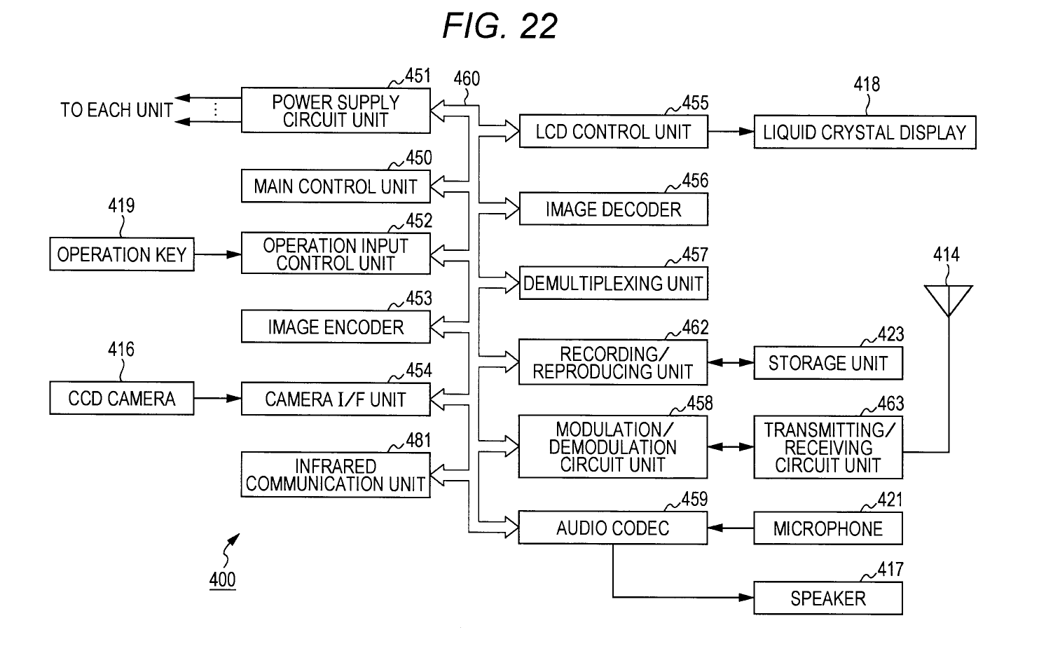

FIG. 22 is a block diagram showing an example of a main configuration of a portable phone set using the image encoding apparatus and the image decoding apparatus to which the present invention is applied.

A portable phone set 400 shown in FIG. 22 includes a main control unit 450 which comprehensively controls each part, a power supply circuit unit 451, an operation input control unit 452, an image encoder 453, a camera I/F unit 454, an LCD control unit 455, an image decoder 456, a demultiplexing unit 457, a recording/reproducing unit 462, a modulating/demodulating circuit unit 458, and an audio codec 459. These are connected together via a bus 460.

The portable phone set 400 includes an operation key 419, a CCD (Charge Coupled Devices) camera 416, a liquid crystal display 418, a storage unit 423, a transmitting/receiving circuit unit 463, an antenna 414, a microphone 421, and a speaker 417.

When a call is finished or a power supply key is turned on by an operation of a user, the power supply circuit unit 451 supplies power to each part from a battery pack, thereby activating the portable phone set 400 to be brought into an operable state.

The portable phone set 400 performs various operations, such as transmission/reception of audio signals, transmission/reception of e-mails or image data, image photographing, or storage of data, in various modes, such as an audio conversation mode and a data communication mode, based on the control of the main control unit 450 including a CPU, a ROM, and a RAM, for example.

In the audio conversation mode, for example, the portable phone set 400 converts the audio signals obtained by collecting sound by the microphone 421 into digital audio data by the audio codec 459, performs spread spectrum processing by the modulating/demodulating circuit unit 458, and performs digital-to-analog conversion processing and frequency conversion processing by the transmitting/receiving circuit unit 463. The portable phone set 400 transmits the transmission signal obtained by the conversion processing to a base station, which is not shown, via the antenna 414. The transmission signal (audio signal) transmitted to the base station is supplied to a portable phone set of a communication counterpart via a public telephone network.

In the audio conversation mode, for example, the portable phone set 400 amplifies the received signal received via the antenna 414 by the transmitting/receiving circuit unit 463. Furthermore, the portable phone set 400 performs frequency conversion processing and analog-to-digital conversion processing, performs spectrum back diffusion processing by the modulating/demodulating circuit unit 458, and performs conversion into an analog audio signal by the audio codec 459. The portable phone set 400 outputs the analog audio signal obtained after the conversion from the speaker 417.

When an e-mail is transmitted in the data communication mode, for example, the portable phone set 400 receives text data of the e-mail, which is input through the operation of the operation key 419, in the operation input control unit 452. The portable phone set 400 processes the text data in the main control unit 450, and causes the liquid crystal display 418 to display the data as an image through the LCD control unit 455.

The portable phone set 400 generates e-mail data based on the text data, user instruction, or the like received by the operation input control unit 452 in the main control unit 450. The portable phone set 400 performs spread spectrum processing on the e-mail data by the modulating/demodulating circuit unit 458, and performs digital-to-analog conversion processing and frequency conversion processing by the transmitting/receiving circuit unit 463. The portable phone set 400 transmits the transmission signal obtained by the conversion processing to a base station, which is not shown, via the antenna 414. The transmission signal (e-mail) transmitted to the base station is supplied to a predetermined destination via a network, a mail server, and the like.

When an e-mail is received in the data communication mode, for example, the portable phone set 400 receives the signal transmitted from the base station via the antenna 414 by the transmitting/receiving circuit unit 463, amplifies the signal, and performs frequency conversion processing and analog-to-digital conversion processing thereon. The portable phone set 400 performs spectrum back diffusion processing on the received signal by the modulating/demodulating circuit unit 458 to restore the original e-mail data. The portable phone set 400 displays the restored e-mail data on the liquid crystal display 418 through the LCD control unit 455.

Note that the portable phone set 400 can also record (store) the received e-mail data in the storage unit 423 through the recording/reproducing unit 462.

This storage unit 423 is an arbitrary rewritable storage medium. The storage unit 423 may be, for example, a semiconductor memory such as a RAM or a built-in flash memory, a hard disk, or a removable medium such as a magnetic disk, a magneto-optical disk, an optical disk, a USB memory, or a memory card. Other storage media may also be used as a matter of course.

When image data is transmitted in the data communication mode, for example, the portable phone set 400 generates image data in the CCD camera 416 by image photographing. The CCD camera 416 includes an optical device, such as a lens or a diaphragm, and a CCD serving as a photoelectric conversion element, captures an image of an object, and converts the intensity of received light into an electric signal, thereby generating mage data of the object image. The image data is subjected to compression coding in the image encoder 453 through the camera I/F unit 454 by a predetermined encoding system, such as MPEG2 or MPEG4, for example, thereby converting the image data into encoded image data.

The portable phone set 400 uses the image encoding apparatus 51 described above, as the image encoder 453 for performing such processing. Accordingly, the image encoder 453 can achieve an improvement in efficiency due to motion prediction, as in the case of the image encoding apparatus 51.

At the same time, the portable phone set 400 performs analog-to-digital conversion on the audio obtained by collecting sound using the microphone 421 during photographing by the CCD camera 416, in the audio codec 459, and further encodes the audio.

The portable phone set 400 multiplexes the encoded image data supplied from the image encoder 453 and the digital audio data supplied from the audio codec 459, in the demultiplexing unit 457, by a predetermined system. The portable phone set 400 performs spread spectrum processing on the multiplexed data thus obtained by the modulating/demodulating circuit unit 458, and performs digital-to-analog conversion processing and frequency conversion processing by the transmitting/receiving circuit unit 463. The portable phone set 400 transmits the transmission signal obtained by the conversion processing to a base station, which is not shown, via the antenna 414. The transmission signal (image data) transmitted to the base station is supplied to a communication counterpart via a network or the like.

In the case of transmitting no image data, the portable phone set 400 can display the image data generated by the CCD camera 416 on the liquid crystal display 418 via the LCD control unit 455 without involving the image encoder 453.

When data of a moving image file linked to a simple web page or the like is received in the data communication mode, for example, the portable phone set 400 receives the signal transmitted from the base station by the transmitting/receiving circuit unit 463 via the antenna 414, amplifies the signal, and performs frequency conversion processing and analog-to-digital conversion processing thereon. The portable phone set 400 performs spectrum back diffusion processing on the received signal by the modulating/demodulating circuit unit 458 to restore the original multiplexed data. The portable phone set 400 separates the multiplexed data in the demultiplexing unit 457 and divides the data into encoded image data and audio data.

The portable phone set 400 decodes the encoded image data in the image decoder 456 by a decoding system corresponding to a predetermined encoding system such as MPEG2 or MPEG4, thereby generating reproduced moving image data. This data is displayed on the liquid crystal display 418 through the LCD control unit 455. As a result, for example, moving image data contained in the moving image file linked to a simple web page is displayed on the liquid crystal display 418.

The portable phone set 400 uses the image decoding apparatus 101 described above, as the image decoder 456 for performing such processing. Accordingly, the image decoder 456 can achieve an improvement in efficiency due to motion prediction, as in the case of the image decoding apparatus 101.

At the same time, the portable phone set 400 converts digital audio data into an analog audio signal in the audio codec 459, and outputs the analog audio signal from the speaker 417. As a result, for example, the audio data contained in the moving image file linked to a simple web page is reproduced.

As in the case of an e-mail, the portable phone set 400 can also record (store) the received data linked to a simple web page or the like in the storage unit 423 through the recording/reproducing unit 462.

The portable phone set 400 can analyze the two-dimensional code captured and obtained by the CCD camera 416 in the main control unit 450, and can obtain information recorded in the two-dimensional code.

Furthermore, the portable phone set 400 can communicate with an external device by way of infrared rays by an infrared communication unit 481.

The portable phone set 400 can improve the encoding efficiency by using the image encoding apparatus 51 as the image encoder 453. As a result, the portable phone set 400 can provide encoded data (image data) with a high encoding efficiency to another apparatus.

The portable phone set 400 uses the image decoding apparatus 101 as the image decoder 456, thereby making it possible to improve the encoding efficiency. As a result, the portable phone set 400 can obtain a higher-definition decoded image from the moving image file linked to a simple web page, for example, and can display the image.

Though the case where the portable phone set 400 uses the CCD camera 416 has been described above, an image sensor (CMOS image sensor) using CMOS (Complementary Metal Oxide Semiconductor) may be used in place of the CCD camera 416. Also in this case, the portable phone set 400 can capture an image of an object and generate image data of the object image, as in the case of using the CCD camera 416.

Though the portable phone set 400 has been described above, the image encoding apparatus 51 and the image decoding apparatus 101 can also be applied to any device as in the case of the portable phone set 400, as long as the device has a photographing function and a communication function similar to those of the portable phone set 400, such as a PDA (Personal Digital Assistants), a smartphone, a UMPC (Ultra Mobile Personal Computer), a netbook, and a laptop personal computer.

### [Configuration Example of Hard Disk Recorder]

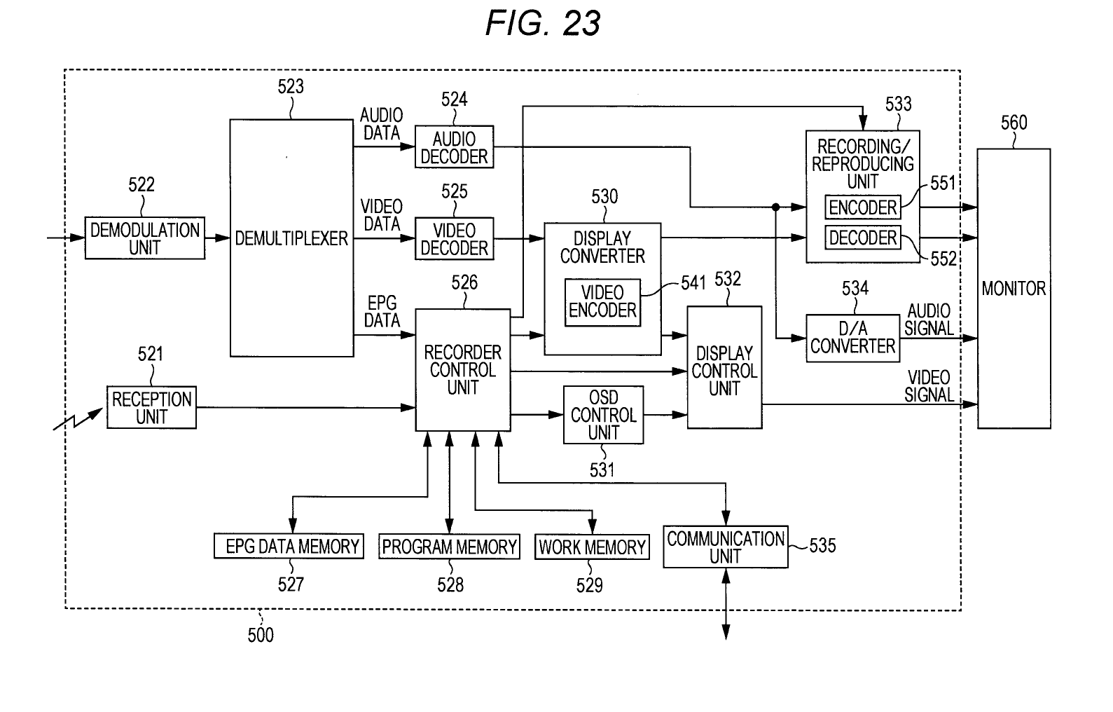

FIG. 23 is a block diagram showing an example of a main configuration of a hard disk recorder using the image encoding apparatus and the image decoding apparatus to which the present invention is applied.

A hard disk recorder (HDD recorder) 500 shown in FIG. 23 is a device that stores, in a built-in hard disk, audio data and video data for a broadcast program included in broadcasting signals (television signals) which are received by a tuner and transmitted via satellite or a ground antenna, and provides the stored data to a user at a timing according to an instruction from the user.

The hard disk recorder 500 can extract the audio data and the video data from the broadcasting signals, for example, decode the data as needed, and store the data in the built-in hard disk. The hard disk recorder 500 can also obtain audio data or video data from another apparatus via a network, for example, decode the data as needed, and store the data in the built-in hard disk.

Furthermore, the hard disk recorder 500 decodes the audio data or video data stored in the built-in hard disk, for example, supplies the data to a monitor 560, and displays the image on the screen of the monitor 560. The hard disk recorder 500 can output the audio from the speaker of the monitor 560.

The hard disk recorder 500 decodes the audio data and video data extracted from the broadcasting signal obtained via a tuner, for example, or the audio data and video data obtained from another apparatus via a network, supplies the decoded data to the monitor 560, and displays the image on the screen of the monitor 560. The hard disk recorder 500 can also output the audio from the speaker of the monitor 560.

As a matter of course, other operations can also be carried out.

As shown in FIG. 23, the hard disk recorder 500 includes a reception unit 521, a demodulation unit 522, a demultiplexer 523, an audio decoder 524, a video decoder 525, and a recorder control unit 526. The hard disk recorder 500 also includes an EPG data memory 527, a program memory 528, a work memory 529, a display converter 530, an OSD (On Screen Display) control unit 531, a display control unit 532, a recording/reproducing unit 533, a D/A converter 534, and a communication unit 535.

The display converter 530 includes a video encoder 541. The recording/reproducing unit 533 includes an encoder 551 and a decoder 552.

The reception unit 521 receives infrared signals from a remote controller (not shown), and converts the infrared signals into electric signals to be output to the recorder control unit 526. The recorder control unit 526 includes a microprocessor, for example, and executes various processing in accordance with the program stored in the program memory 528. At this time, the recorder control unit 526 uses the work memory 529 as needed.

The communication unit 535 is connected to a network, and performs communication processing with another apparatus via the network. For example, the communication unit 535 is controlled by the recorder control unit 526 to communicate with a tuner (not shown), and outputs a selection control signal mainly to the tuner.

The demodulation unit 522 demodulates the signal supplied from the tuner, and outputs the demodulated signal to the demultiplexer 523. The demultiplexer 523 separates the data supplied from the demodulation unit 522 into audio data, video data, and EPG data, and outputs each data to the audio decoder 524, the video decoder 525, or the recorder control unit 526.

The audio decoder 524 decodes the received audio data by the MPEG system, for example, and outputs the decoded data to the recording/reproducing unit 533. The video decoder 525 decodes the received video data by the MPEG system, for example, and outputs the decoded data to the display converter 530. The recorder control unit 526 supplies the received EPG data to the EPG data memory 527 and stores the data therein.

The display converter 530 encodes the video data supplied from the video decoder 525 or the recorder control unit 526, into video data for the NTSC (National Television Standards Committee) system, for example, by the video encoder 541, and outputs the encoded data to the recording/reproducing unit 533. The display converter 530 also converts the size of the screen of video data to be supplied from the video decoder 525 or the recorder control unit 526, into the size corresponding to the size of the monitor 560. The display converter 530 further converts the video data whose screen size has been converted, into video data for the NTSC system by the video encoder 541, and further converts the data into analog signals to be output to the display control unit 532.

Under the control of the recorder control unit 526, the display control unit 532 superimposes an OSD signal output by the OSD (On Screen Display) control unit 531 on a video signal received from the display converter 530, and outputs and displays the signal on the display of the monitor 560.

Audio data output by the audio decoder 524 is converted into an analog signal by the D/A converter 534 and is supplied to the monitor 560. The monitor 560 outputs the audio signal from a built-in speaker.

The recording/reproducing unit 533 includes a hard disk as a storage medium for recording video data, audio data, and the like.

The recording/reproducing unit 533 encodes the audio data supplied from the audio decoder 524, for example, using the MPEG system by the encoder 551. The recording/reproducing unit 533 encodes the video data supplied from the video encoder 541 of the display converter 530 using the MPEG system by the encoder 551. The recording/reproducing unit 533 synthesizes the encoded data of the audio data with the encoded data of the video data by a multiplexer. The recording/reproducing unit 533 amplifies the synthesized data by channel coding, and writes the data into the hard disk via the recording head.

The recording/reproducing unit 533 reproduces and amplifies the data recorded in the hard disk via the reproducing head, and separates the data into audio data and video data by a demultiplexer. The recording/reproducing unit 533 decodes the audio data and the video data by the decoder 552 using the MPEG system. The recording/reproducing unit 533 performs D/A conversion on the decoded audio data, and outputs the data to the speaker of the monitor 560. The recording/reproducing unit 533 performs D/A conversion on the decoded video data, and outputs the data to the display of the monitor 560.

The recorder control unit 526 reads the latest EPG data from the EPG data memory 527 based on the user instruction indicated by the infrared signal from the remoter controller received via the reception unit 521, and supplies the data to the OSD control unit 531. The OSD control unit 531 generates image data corresponding to the received EPG data, and outputs the data to the display control unit 532. The display control unit 532 outputs the video data input by the OSD control unit 531 to the display of the monitor 560, and displays the data thereon. As a result, an EPG (electronic program guide) is displayed on the display of the monitor 560.

The hard disk recorder 500 can also obtain various data such as the video data, audio data, or EPG data supplied from another apparatus via a network such as the Internet.

The communication unit 535 is controlled by the recorder control unit 526, obtains encoded data such as the video data, audio data, and EPG data transmitted from another apparatus via a network, and supplies the data to the recorder control unit 526. The recorder control unit 526 supplies the encoded data of the obtained video data or audio data, for example, to the recording/reproducing unit 533, and stores the data in the hard disk. At this time, the recorder control unit 526 and the recording/reproducing unit 533 may perform processing such as reencoding, as needed.

The recorder control unit 526 decodes the encoded data of the obtained video data or audio data, and supplies the obtained video data to the display converter 530. The display converter 530 processes the video data supplied from the recorder control unit 526, as in the case of the video data supplied from the video decoder 525, supplies the data to the monitor 560 through the display control unit 532, and displays the image.

In accordance with the image display, the recorder control unit 526 may supply the decoded audio data to the monitor 560 through the D/A converter 534, and may output the audio from the speaker.

Further, the recorder control unit 526 decodes the encoded data of the obtained EPG data, and supplies the decoded EPG data to the EPG data memory 527.

The hard disk recorder 500 described above uses the image decoding apparatus 101 as the video decoder 525, the decoder 552, and the decoder incorporated in the recorder control unit 526. Accordingly, the video decoder 525, the decoder 552, and the decoder incorporated in the recorder control unit 526 can achieve an improvement in efficiency due to motion prediction, as in the case of the image decoding apparatus 101.

Accordingly, the hard disk recorder 500 can generate a predicted image with high accuracy. As a result, the hard disk recorder 500 can obtain a higher-definition decoded image from the encoded data of the video data received via a tuner, for example, the encoded data of the video data read from the hard disk of the recording/reproducing unit 533, and the encoded data of the video data obtained via a network, and can display the obtained image on the monitor 560.

The hard disk recorder 500 uses the image encoding apparatus 51 as the encoder 551. Accordingly, the encoder 551 can achieve an improvement in efficiency due to motion prediction, as in the case of the image encoding apparatus 51.

Accordingly, the hard disk recorder 500 can improve the encoding efficiency of the encoded data to be recorded in the hard disk, for example. As a result, the hard disk recorder 500 can effectively use the storage area of the hard disk.

Though the hard disk recorder 500 that records the video data and audio data in the hard disk has been described above, any recording media may be used, as a matter of course. For example, the image encoding apparatus 51 and the image decoding apparatus 101 can be applied to a recorder that is applied to recording media other than the hard disk, such as a flash memory, an optical disk, or a video tape, as in the case of the hard disk recorder 500 described above.

### [Configuration Example of Camera]

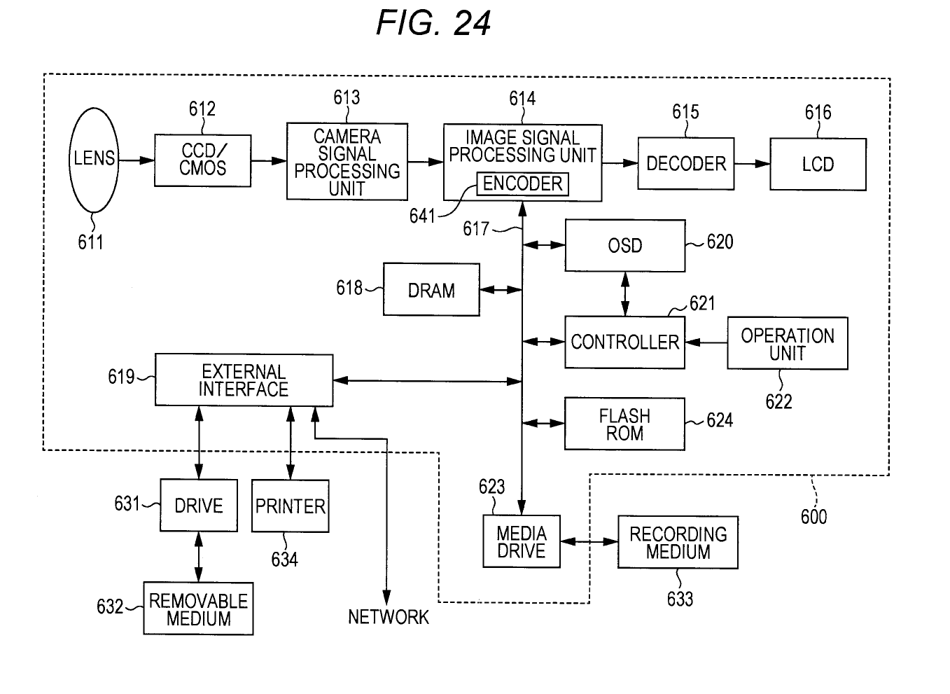

FIG. 24 is a block diagram showing an example of a main configuration of a camera using an image decoding apparatus and an image encoding apparatus to which the present invention is applied.

A camera 600 shown in FIG. 24 captures an image of a subject, displays the image of the subject on an LCD 616, or stores the image as image data in a recording medium 633.

A lens block 611 allows light (specifically, a video of an object) to be incident on a CCD/CMOS 612. The CCD/CMOS 612 is an image sensor using a CCD or a CMOS. The CCD/CMOS 612 converts the intensity of received light into an electric signal, and supplies the electric signal to a camera signal processing unit 613.

The camera signal processing unit 613 converts the electric signals supplied from the CCD/CMOS 612 into color-difference signals of Y, Cr, and Cb, and supplies the converted signals to an image signal processing unit 614. The image signal processing unit 614 performs predetermined image processing on the image signals supplied from the camera signal processing unit 613 under the control of a controller 621, or encodes the image signals in an encoder 641 by using an MPEG system, for example. The image signal processing unit 614 supplies the encoded data, which is generated by encoding the image signals, to a decoder 615. Furthermore, the image signal processing unit 614 obtains display data generated in an on-screen display (OSD) 620, and supplies the obtained display data to the decoder 615.

In the above-mentioned processing, the camera signal processing unit 613 utilizes a DRAM (Dynamic Random Access Memory) 618 connected via a bus 617, as needed, and allows image data and encoded data obtained by encoding the image data to be retained in the DRAM 618, as needed.

The decoder 615 decodes the encoded data supplied from the image signal processing unit 614, and supplies the obtained image data (decoded image data) to the LCD 616. The decoder 615 supplies display data supplied from the image signal processing unit 614 to the LCD 616. The LCD 616 synthesizes an image of decoded image data supplied from the decoder 615 with an image of the display data, and displays the synthesized image.

Under the control of the controller 621, the on-screen display 620 outputs a menu screen composed of symbols, characters, or figures or display data such as icons via the bus 617 to the image signal processing unit 614.

On the basis of signals indicating contents instructed by the user by using an operation unit 622, the controller 621 executes various processing and also controls the image signal processing unit 614, the DRAM 618, an external interface 619, the on-screen display 620, a media drive 623, and the like via the bus 617. A flash ROM 624 stores programs, data, and the like necessary for the controller 621 to execute various processing.

For example, the controller 621 can encode the image data stored in the DRAM 618 or decode the encoded data stored in the DRAM 618, in place of the image signal processing unit 614 and the decoder 615. At this time, the controller 621 may perform encoding/decoding processing by a system similar to the encoding/decoding system of each of the image signal processing unit 614 and the decoder 615, or may perform encoding/decoding processing by a system which is not supported by the image signal processing unit 614 and the decoder 615.

When a start of image printing is instructed from the operation unit 622, for example, the controller 621 reads the image data from the DRAM 618, and supplies the image data to a printer 634 connected to the external interface 619 via the bus 617 to cause the printer to print the image data.

Furthermore, for example, when image recording is instructed from the operation unit 622, the controller 621 reads the encoded data from the DRAM 618, and supplies the encoded data to the recording medium 633 mounted to the media drive 623 via the bus 617 to cause the recording media to store the data.

The recording medium 633 is, for example, a magnetic disk, a magneto-optical disk, an optical disk, or an arbitrary readable/writable removable medium such as a semiconductor memory. The recording medium 633 may be any type of removable media, a tape device, a disk, a memory card, or a non-contact IC card, for example, as a matter of course.

The media drive 623 and the recording medium 633 may be integrated together, for example, and may be formed of non-portable storage media, such as a built-in hard disk drive or an SSD (Solid State Drive).

The external interface 619 includes a USB input/output terminal, for example, and is connected to the printer 634 in the case of printing an image. The external interface 619 is connected to a drive 631 as needed, and is mounted with removable media 632, such as a magnetic disk, an optical disk, or magneto-optical disk, as needed. A computer program read from the removable media is installed in the flash ROM 624, as needed.

Furthermore, the external interface 619 has a network interface connected to a predetermined network such as LAN or the Internet. For example, while following an instruction from the operation unit 622, the controller 621 can read the encoded data from the DRAM 618 and supply it from the external interface 619 to another apparatus connected via the network. Also, the controller 621 can obtain the encoded data or the image data supplied from another apparatus via the network via the external interface 619 to cause the DRAM 618 to hold it or supply to the image signal processing unit 614.

The above-mentioned camera 600 uses the image decoding apparatus 101 as the decoder 615. Therefore, the decoder 615 can achieve an improvement in efficiency due to motion prediction, as in the case of the image decoding apparatus 101.

Accordingly, the camera 600 can generate a predicted image with high accuracy. As a result, the camera 600 can obtain a higher-definition decoded image from the image data generated in the CCD/CMOS 612, the encoded data of the video data read from the DRAM 618 or the recording medium 633, or the encoded data of the video data obtained via a network, and can display the obtained image on the LCD 616.

Also, the camera 600 uses the image encoding apparatus 51 as the encoder 641. Therefore, the encoder 641 can achieve an improvement in efficiency due to motion prediction, as in the case of the image encoding apparatus 51.

Therefore, the camera 600 can improve the encoding efficiency of the encoded data to be recorded, for example, on the hard disk. As a result, the camera 600 can use the storage area of the DRAM 618 and the recording medium 633 more efficiently.

Note that the decoding method of the image decoding apparatus 101 may be applied to the decoding processing carried out by the controller 621. Similarly, the encoding method of the image encoding apparatus 51 may be applied to the encoding processing performed by the controller 621.

Also, the image data picked up by the camera 600 may be a moving image or may be a still image.

As a matter of course, the image encoding apparatus 51 and the image decoding apparatus 101 can also be applied to apparatuses and systems other than the above-mentioned apparatuses.

### REFERENCE SIGNS LIST

51 Image encoding apparatus
66 Lossless encoding unit
74 Intra-prediction unit
75 Motion prediction/compensation unit
76 Motion vector interpolation unit
81 Motion search unit
82 Motion compensation unit
83 Cost function calculation unit
84 Optimum inter mode determination unit
91 Block address buffer
92 Motion vector calculation unit
101 Image decoding apparatus
112 Lossless decoding unit
121 Intra-prediction unit
122 Motion compensation unit
123 Motion vector interpolation unit
131 Motion vector buffer
132 Predicted image generation unit
141 Motion vector calculation unit
142 Block address buffer

1. An image processing apparatus comprising:
motion search means for selecting a plurality of sub blocks according to a macro block size from a macro block to be encoded, and for searching motion vectors of selected sub blocks;
motion vector calculation means for calculating motion vectors of non-selected sub blocks by using the motion vectors of the selected sub blocks and a weighting factor according to a positional relation in the macro block; and
encoding means for encoding an image of the macro block and the motion vectors of the selected sub blocks.

2. The image processing apparatus according to claim 1, wherein the motion search means selects sub blocks at four corners from the macro block.

3. The image processing apparatus according to claim 1, wherein the motion vector calculation means calculates a weighting factor according to a positional relation between the selected sub blocks in the macro block and the non-selected sub blocks, and multiplies and adds the calculated weighting factor and the motion vectors of the selected sub blocks to calculate the motion vectors of the non-selected sub blocks.

4. The image processing apparatus according to claim 3, wherein the motion vector calculation means uses linear interpolation as a method for calculating the weighting factor.

5. The image processing apparatus according to claim 3, wherein the motion vector calculation means performs rounding processing of the calculated motion vectors of the non-selected sub blocks on a prescribed motion vector accuracy after multiplication of the weighting factor.

6. The image processing apparatus according to claim 1, wherein the motion search means searches the motion vectors of the selected sub blocks by block matching of the selected sub blocks.

7. The image processing apparatus according to claim 1, wherein the motion search means calculates a residual signal for any combination of motion vectors within a search range with respect to the selected sub blocks, and obtains a combination of motion vectors that minimizes a cost function value using the calculated residual signal to search the motion vectors of the selected sub blocks.

8. The image processing apparatus according to claim 1, wherein the encoding means encodes Warping mode information indicating a mode for encoding only the motion vectors of the selected sub blocks.

9. An image processing method comprising:
selecting, by motion search means of an image processing apparatus, a plurality of sub blocks according to a macro block size from a macro block to be encoded and searching motion vectors of the selected sub blocks;
calculating, by motion vector calculation means of the image processing apparatus, motion vectors of non-selected sub blocks by using the motion vectors of the selected sub blocks and a weighting factor according to a positional relation in the macro block; and
encoding, by encoding means of the image processing apparatus, an image of the macro block and the motion vectors of the selected sub blocks.

10. An image processing apparatus comprising:
decoding means for decoding an image of a macro block to be decoded and motion vectors of sub blocks selected according to a macro block size from the macro block upon encoding;
motion vector calculation means for calculating motion vectors of non-selected sub blocks by using the motion vectors of the selected sub blocks decoded by the decoding means and a weighting factor according to a positional relation in the macro block; and
predicted image generation means for generating a predicted image of the macro block by using the motion vectors of the selected sub blocks decoded by the decoding means and the motion vectors of the non-selected sub blocks calculated by the motion vector calculation means.

11. The image processing apparatus according to claim 10, wherein the selected sub blocks are sub blocks at four corners.

12. The image processing apparatus according to claim 10, wherein the motion vector calculation means calculates a weighting factor according to the positional relation between the selected sub blocks in the macro block and the non-selected sub blocks, and multiplies and adds the calculated weighting factor and the motion vectors of the selected sub blocks to calculate the motion vectors of the non-selected sub blocks.

13. The image processing apparatus according to claim 12, wherein the motion vector calculation means uses linear interpolation as a method for calculating the weighting factor.

14. The image processing apparatus according to claim 12, wherein the motion vector calculation means performs rounding processing of the calculated motion vectors of the non-selected sub blocks on a prescribed motion vector accuracy after multiplication of the weighting factor.

15. The image processing apparatus according to claim 10, wherein the motion vectors of the selected sub blocks are searched and encoded by block matching of the selected sub blocks.

16. The image processing apparatus according to claim 10, wherein the motion vectors of the selected sub blocks are searched and encoded by calculating a residual signal for any combination of motion vectors within a search range with respect to the selected sub blocks and by obtaining a combination of motion vectors that minimizes a cost function value using the calculated residual signal.

17. The image processing apparatus according to claim 10, wherein the decoding means decodes Warping mode information indicating a mode for encoding only the motion vectors of the selected sub blocks.

18. An image processing method comprising:
decoding, by decoding means of an image processing apparatus, an image of a macro block to be decoded and motion vectors of sub blocks selected according to a macro block size from the macro block upon encoding;
calculating, by motion vector calculation means of the image processing apparatus, motion vectors of non-selected sub blocks by using the decoded motion vectors of the selected sub blocks and a weighting factor corresponding to a positional relation in the macro block; and
generating, by predicted image generation means of the image processing apparatus, a predicted image of the macro block by using the decoded motion vectors of the selected sub blocks and the calculated motion vectors of the non-selected sub blocks.
